(19) United States
(12) Patent Application Publication
(10) Pub. No.: US 2026/0161968 A1
(43) Pub. Date: Jun. 11, 2026

(54) INFERENCE PROCESSING UNIT WITH HIGH BANDWIDTH NON-VOLATILE MEMORY NEAR MEMORY COMPUTING

(71) Applicant: Sandisk Technologies, Inc., Milpitas, CA (US)

(72) Inventors: Liang Li, Shanghai (CN); Yan Li, Milpitas, CA (US)

(73) Assignee: Sandisk Technologies, Inc., Milpitas, CA (US)

(21) Appl. No.: 18/977,519

(22) Filed: Dec. 11, 2024

(51) Int. Cl. G06N 5/04

(52) U.S. Cl. CPC G06N 5/04

(57) ABSTRACT

An inferencing processing unit (IPU) and system having high bandwidth non-volatile near memory computing. The IPU has a logic die and one or more memory dies that have non-volatile memory. The logic die may contain inference engines and Error Correction Code (ECC) engines. The NAND memory may be used to store parameters of a trained model for the inference engines as part of an artificial intelligence application. The logic performs a high bandwidth read of the parameters and provide the parameters to the inference engines for parallel computation.

### BACKGROUND

The present disclosure relates to an inferencing processing unit with high bandwidth non-volatile near memory computing.

Semiconductor memory is widely used in various electronic devices such as cellular telephones, digital cameras, personal digital assistants, medical electronics, mobile computing devices, servers, solid state drives, non-mobile computing devices and other devices. Semiconductor memory may comprise non-volatile memory or volatile memory. Non-volatile memory allows information to be stored and retained even when the non-volatile memory is not connected to a source of power (e.g., a battery). One example of non-volatile memory is flash memory (e.g., NAND-type and NOR-type flash memory).

Users of non-volatile memory can program (e.g., write) data to the non-volatile memory and later read that data back. For example, a digital camera may take a photograph and store the photograph in non-volatile memory. Later, a user of the digital camera may view the photograph by having the digital camera read the photograph from the non-volatile memory.

Artificial Intelligence (AI) technology, particularly large models like GPT-4, DALL-E, and other foundation models, is enhancing human capability, revolutionizing multiple industries and addressing global challenges. The semiconductor industry has been fundamental to the AI revolution, providing the powerful, efficient hardware necessary to train and deploy increasingly complex models. The GPU+HBM (High Bandwidth Memory) architecture is one of mainstream crucial architectures because it provides the performance, efficiency, and scalability necessary to handle massive AI workloads. GPUs are designed to handle highly parallel computations, making them suitable for the vast matrix operations and data processing needs in AI tasks such as deep learning. HBM offers much higher bandwidth compared to traditional GDDR memory, allowing GPUs to access more data per second. This directly accelerates the training and inference speeds for large AI models by mitigating bottlenecks in data access. The enhanced bandwidth of HBM also supports the high demands of model training, where massive amounts of data need to be loaded quickly and efficiently into GPU cores.

Although the GPU+HBM architecture has many advantages, it does come with notable drawbacks. The HBM architecture typically has a stack containing DRAM dies and a logic die. The GPU is typically added by placing the GPU and the HBM onto an interposer. Signals between the logic die and GPU are routed through the interposer. Moreover, the logic die typically has through silicon vias (TSVs). Thus, a conventional GPU+HBM architecture uses an interposer between the GPU and the HBM. Also, the logic die that connects the HBM to the interposer may have through silicon vias (TSVs). Both the interposer and TSVs in the logic die add expense and complexity to the manufacturing process.

Another drawback of the GPU+HBM architecture is limited memory capacity. Although HBM offers high bandwidth, it has a relatively low memory capacity ceiling compared to other types of memory. As AI models continue to grow, the capacity limitations of HBM could become a bottleneck, especially for applications that require vast datasets or extremely large models.

There are also system compatibility and flexibility issues with the GPU+HBM architecture. Not all systems are compatible with HBM-equipped GPUs, which may therefore require customized infrastructure with less flexibility.

While HBM is designed to be power-efficient for high bandwidth operations, it can still consume substantial power due to the massive amount of data needed move from HBM to GPU through TSVs and interposer.

Furthermore, the GPU+HBM architecture may result in underutilization in smaller AI models. For smaller AI models (e.g., mobile usage), the benefits of HBM may be underutilized, making the high-performance architecture less cost-effective.

Moreover, the GPU+HBM architecture is not well-suited for diverse arithmetic density. For example, tasks requiring flexible, lower-density arithmetic operations are not well-suited for the GPU+HBM architecture. Although the GPU+HBM architecture excels in dense floating-point computations (ideal for training large models), it is less suited for tasks involving varied arithmetic, such as sparse data processing or integer-heavy inference tasks.

Additionally, the GPU+HBM architecture may suffer from an imbalance between computational power and memory. AI inference tasks often involve sparse data matrices, where only a fraction of the data contains meaningful values. GPUs generally excel in dense operations, meaning sparse data may not utilize the computational power effectively, particularly in architectures where memory speed is optimized at the cost of memory size. For inference tasks and data-intensive applications high memory capacity may be more valuable than high memory bandwidth. This imbalance can lead to underutilization of GPU resources, inefficient power consumption, and scalability issues for larger models.

### BRIEF DESCRIPTION OF THE DRAWINGS

Like-numbered elements refer to common components in the different figures.

FIG. 1A is a block diagram of one embodiment of a system having a number of IPUs.

FIG. 1B is a block diagram depicting one embodiment of an IPU.

FIG. 2A is a block diagram of one embodiment of a memory die that may be included in an IPU.

FIG. 2B is a block diagram of one embodiment of an integrated memory assembly (also referred to as a memory die) that may be included in an IPU.

FIGS. 3A, 3B, and 3C show side views of embodiments of an IPU.

FIG. 3D shows a side view of one embodiment of a system having an IPU and a host on a PCB.

FIG. 3E shows a side view of one embodiment of a system having an IPU and a host on an interposer.

FIG. 4 is a block diagram of one embodiment of a logic die that may be used in an embodiment of an IPU with non-volatile memory.

FIG. 5 is a block diagram of another embodiment of a logic die that may be used in an embodiment of an IPU with non-volatile memory.

FIG. 6 is a flowchart of one embodiment of a process of performing inferencing using high bandwidth non-volatile memory with near memory compute.

FIG. 7 depicts one embodiment of a non-volatile memory system capable of performing a high bandwidth read process for an IPU.

FIG. 8A is a block diagram of one layer of a stack of memory die that may be included in an embodiment of an IPU.

FIG. 8B is a block diagram of one layer of a stack of memory die that may be included in an embodiment of an IPU.

FIG. 9 is a block diagram depicting a partial floor plan for a memory die that may be included in an embodiment of an IPU.

FIG. 10 is a block diagram depicting a partial floor plan for a memory die that may be included in an embodiment of an IPU.

FIG. 11 is a block diagram depicting a partial floor plan for a memory die that may be included in an embodiment of an IPU.

FIG. 12 is a block diagram depicting a partial floor plan for a memory die that may be included in an embodiment of an IPU.

FIG. 13 is a block diagram depicting a partial floor plan for a memory die that may be included in an embodiment of an IPU.

FIG. 14 is a flow chart describing one embodiment of a process for operating an IPU with a high bandwidth read of NAND.

FIG. 15A is a system level timing diagram for a high bandwidth read process.

FIG. 15B is a die level timing diagram for a high bandwidth read process.

FIG. 16 is a block diagram of a memory controller that may be used in an IPU.

FIG. 17 is a block diagram depicting data flow at the memory controller during a high bandwidth read process in an IPU.

FIG. 18 is a block diagram depicting error correction performed at the memory controller during a high bandwidth read process in an IPU.

FIG. 19 is a perspective view of a portion of one embodiment of a monolithic three dimensional memory structure.

FIG. 19A is a block diagram of one embodiment of a memory structure having two planes.

FIG. 19B depicts a top view of a portion of one embodiment of a block of memory cells.

FIG. 19C depicts a cross sectional view of a portion of one embodiment of a block of memory cells.

FIG. 19D depicts a cross sectional view of a portion of one embodiment of a block of memory cells.

FIG. 19E is a cross sectional view of one embodiment of a vertical column of memory cells.

FIG. 20A depicts threshold voltage distributions.

FIG. 20B depicts threshold voltage distributions.

### DETAILED DESCRIPTION

An inferencing processing unit (IPU) and system having high bandwidth non-volatile near memory computing is disclosed. The IPU has a logic die and one or more memory dies that have non-volatile memory. In some embodiments, the non-volatile memory is Flash (e.g., NAND, NOR). The logic die may contain inference engines and Error Correction Code (ECC) engines. The NAND memory may be used to store a trained model for the inference engines as part of an artificial intelligence application. Typically, the trained model is programmed into the non-volatile memory once and then read many times. To support the input needs of the inference engine, the process of reading the model should be performed at a high bandwidth. Typically, DRAM is used to store a trained model. However, non-volatile memory such as NAND memory can be less expensive than DRAM. Therefore, deploying non-volatile memory such as NAND memory to store the trained model and being able to read the data for the model at the expected bandwidth allows for significant cost savings. Herein, numerous examples in which the non-volatile memory is NAND will be discussed. However, the non-volatile memory is not limited to NAND.

An embodiment includes a number of IPUs that may reside on a surface of a substrate such as a printed circuit board (PCB) or an interposer. A processing unit (e.g., CPU, GPU) may also reside on the surface of a substrate. The processing unit may provide input data to the IPUs, which load in the AI parameters from the NAND memory, decode the data from the NAND, and operate inference engines to generate inference results. The inference results are provided to the processing unit. An interposer between the IPUs and the processing unit is optional. Therefore, expense and complexity to the manufacturing process may be reduced if the interposer is not used. However, the IPU itself is not required to have an interposer. Thus, data transfer latency can be improved relative to the GPU+HBM architecture. Meanwhile, the power consumption and corresponding manufacture complexity can be mitigated.

An embodiment includes an IPU having non-volatile memory such as NAND, which has a very high memory capacity. For example, NAND can store far more data per unit of physical space than DRAM. An embodiment includes an IPU with non-volatile memory such as NAND, which is very power efficient. The logic die in the IPU is not required to have TSVs. Avoiding TSVs in the logic die reduces die size. The reduction in die size may be used to increase the number of inference engines and ECC circuits. Moreover, the IPU is not required to have an interposer. In an embodiment there is no interposer between the logic die and memory dies.

An embodiment includes an IPU that is well-suited for a wide range of sizes of AI models. An embodiment includes an IPU that is well-suited for diverse arithmetic density. For example, tasks involving varied arithmetic, such as sparse data processing or integer-heavy inference tasks may be performed efficiently in an embodiment of an IPU.

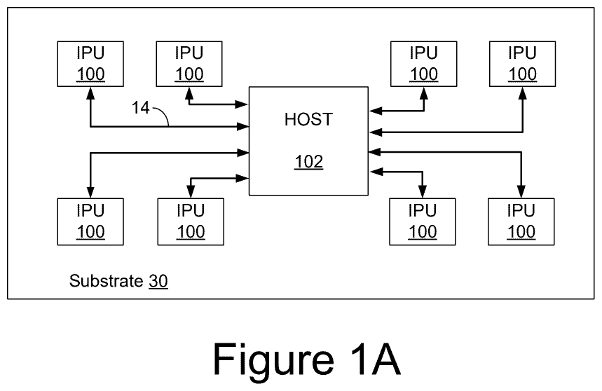

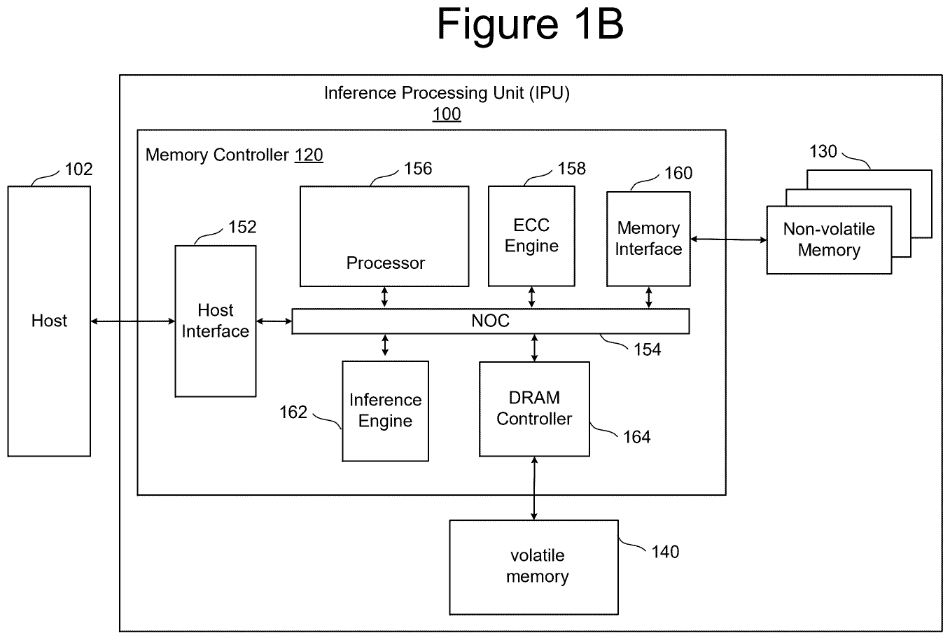

FIG. 1A is a block diagram of one embodiment of a system having a number of IPUs. The system may be used for an artificial intelligence application. The system has a host 120 and a number of inference processing units (IPU) 100. Each IPU 100 contains high bandwidth non-volatile memory (e.g., NAND) and inference engines. Examples will be discussed in which the non-volatile memory in the IPU 100 is NAND, but the non-volatile memory in the IPU 100 is not limited to NAND. Each IPU 100 is connected to the host 102 over a communication interface 14. The host 102 may include one or more processing units such as a central processing unit (CPU), graphics processing unit (GPU), etc. As one example, the communication interface 14 may be Universal Chiplet Interconnected Express (UCIe), although another protocol could be used. Each IPU 100 communicates with the host 102 to allow the host 102 to provide data to be stored in the high-bandwidth non-volatile memory. The data provided by the host 102 may include parameters (e.g., weights) of an AI model. The IPUs 100 may store the parameters in the high-bandwidth non-volatile memory. The IPUs 100 may encode the data prior to storing in high-bandwidth non-volatile memory. During the inferencing stage, the host 102 may provide input data to the IPUs 100. Each IPU 100 may read the parameters of the AI model from its high bandwidth NAND memory and provide the parameters to its inference engines. Each IPU 100 has ECC circuits to decode the data read from the high-bandwidth non-volatile memory. The neural network may contain a number of layers, as is known in the art. The inference engines of a given IPU 100 may perform calculations in parallel thereby producing intermediate results, which may be temporarily stored in the high-bandwidth non-volatile memory. The intermediate results may be read from the high-bandwidth non-volatile memory and provided to other layers in the neural network. Final results of the inference engine may be provided to the host 102.

The IPUs 100 and the host 102 may reside on a surface of a substrate 30. The substrate 30 may be, for example, a printed circuit board (PCB) or an interposer. The electrical connections between the host 102 and the IPUs 100 may be made by, for example, PCB traces if the substrate 30 is a PCB. The substrate 30 may optionally be an interposer. However, the system does not need any interposers within the IPUs 100. The architecture in FIG. 1A avoids underutilization in smaller models. The architecture in FIG. 1A avoids imbalance between computational power and memory.

FIG. 1B is a block diagram of one embodiment of an inference processing unit 100 that implements the proposed technology described herein. IPU 100 is connected to host 102. The IPU 100 may implement one of the IPUs 100 in FIG. 1A. The host 102 may be the host 102 in FIG. 1A. The host 102 may include, for example, a CPU, GPU, etc. In an embodiment, the host 102 provides parameters (e.g., weights) of an AI model, which the memory controller 120 stores in the non-volatile memory 130.

The components of IPU 100 depicted in FIG. 1B are electrical circuits. IPU 100 includes a memory controller 120 connected to non-volatile memory 130 and local high speed volatile memory 140 (e.g., DRAM). Local high speed volatile memory 140 is used by memory controller 120 to perform certain functions. For example, local high speed volatile memory 140 may be used for buffers to temporarily store data read from the memory 130.

Memory controller 120 comprises a host interface 152 that is connected to and in communication with host 102. In one embodiment, host interface 152 implements a UCIe interface. Other interfaces can also be used. Host interface 152 is also connected to a network-on-chip (NOC) 154. A NOC is a communication subsystem on an integrated circuit. NOC's can span synchronous and asynchronous clock domains or use unclocked asynchronous logic. NOC technology applies networking theory and methods to on-chip communications and brings notable improvements over conventional bus and crossbar interconnections. NOC improves the scalability of systems on a chip (SoC) and the power efficiency of complex SoCs compared to other designs. The wires and the links of the NOC are shared by many signals. A high level of parallelism is achieved because all links in the NOC can operate simultaneously on different data packets. Therefore, as the complexity of integrated subsystems keep growing, a NOC provides enhanced performance (such as throughput) and scalability in comparison with previous communication architectures (e.g., dedicated point-to-point signal wires, shared buses, or segmented buses with bridges). In other embodiments, NOC 154 can be replaced by a bus. Connected to and in communication with NOC 154 is processor 156, inference engine 162, ECC engine 158, memory interface 160, and DRAM controller 164. DRAM controller 164 is used to operate and communicate with local high speed volatile memory 140 (e.g., DRAM). In other embodiments, local high speed volatile memory 140 can be SRAM or another type of volatile memory.

The inference engine 162 may be used for computations in an artificial intelligence (AI) application. The inference engine 162 may be implemented in software and/or hardware. Although depicted as separate from the processor 156, the inference engine 162 may be implemented in whole or in part on the processor 156. In an embodiment, the inference engine 162 contains a large number of separate computing units that may be operated in parallel. These separate computing units may include a number of similar (or identical) computing units that may perform the same time of computation (e.g., matrix multiplication). Multiple uniform inference engines can help achieve parallel computation during inference. However, the separate computing units may also include different types of computing units, such as, but not limited to, tensor engines and sparsity-friendly engines. Such additional engines can address issues of computational power underutilization for sparse or mixed-precision data.

ECC engine 158 performs error correction. For example, ECC engine 158 performs data encoding and decoding, as per the implemented ECC technique. The ECC engine 158 may be used to encode the parameters (e.g., weights) received from the host 102 prior to storage in the non-volatile memory 130. In an embodiment, the ECC engine 158 contains a number of individual ECC circuits (also referred to as ECC engines) that may be operated in parallel. Therefore, ECC engine 158 is able to decode data from more than one memory die in parallel. The ECC engine 158 could also be used to decode data from different planes of the same memory die in parallel. The ECC engine 158 may be implemented in hardware and/or software. In an embodiment, ECC engine 158 contains one or more custom and dedicated hardware circuits. In one embodiment, ECC engine 158 can include a processor that can be programmed. In an embodiment, the function of ECC engine 158 is implemented by processor 156.

Processor 156 oversees the inferencing process. Processor 156 performs the various controller memory operations, such as programming, erasing, reading, and memory management processes (e.g., data refresh). Processor 156 oversees the storage of the parameters (e.g., weights) for the AI model in the memory 130, as well as the retrieval of the parameters when inferencing is to be performed. Processor 156 provides the data read from the memory 130 to the ECC engine 158. After successful decoding, the decoded data is provided to the inference engine 162.

In one embodiment, processor 156 is programmed by firmware. In other embodiments, processor 156 is a custom and dedicated hardware circuit without any software. In some embodiments, a portion of the non-volatile memory 130 is made available for the host 102 to store and retrieve data. However, it is not required that the host 102 be permitted to retrieve data from the non-volatile memory 130. If host is permitted to store and retrieve data, the processor 156 may also implement a translation module, as a software/firmware process or as a dedicated hardware circuit. The memory controller 120 (e.g., the translation module) may perform address translation between logical addresses used by the host and physical addresses used by the memory dies. One example implementation is to maintain tables (e.g., logical to physical or L2P tables) that identify the current translation between logical addresses and physical addresses. An entry in the L2P table may include an identification of a logical address and corresponding physical address.

Memory interface 160 communicates with non-volatile memory 130. In one embodiment, memory interface provides a Toggle Mode interface. Other interfaces can also be used. In some example implementations, memory interface 160 (or another portion of controller 120) implements a scheduler and buffer for transmitting data to and receiving data from one or more memory die.

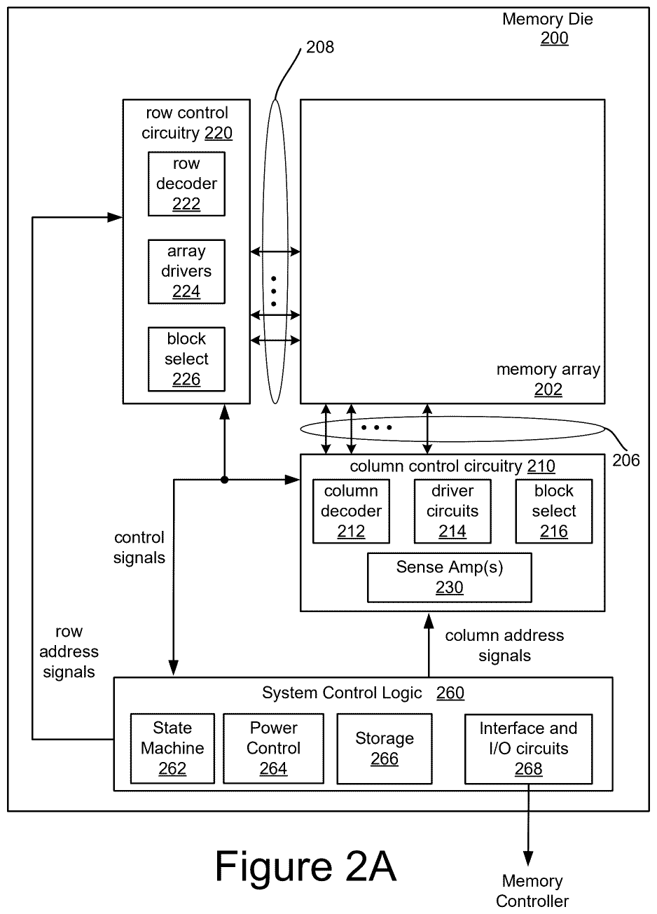

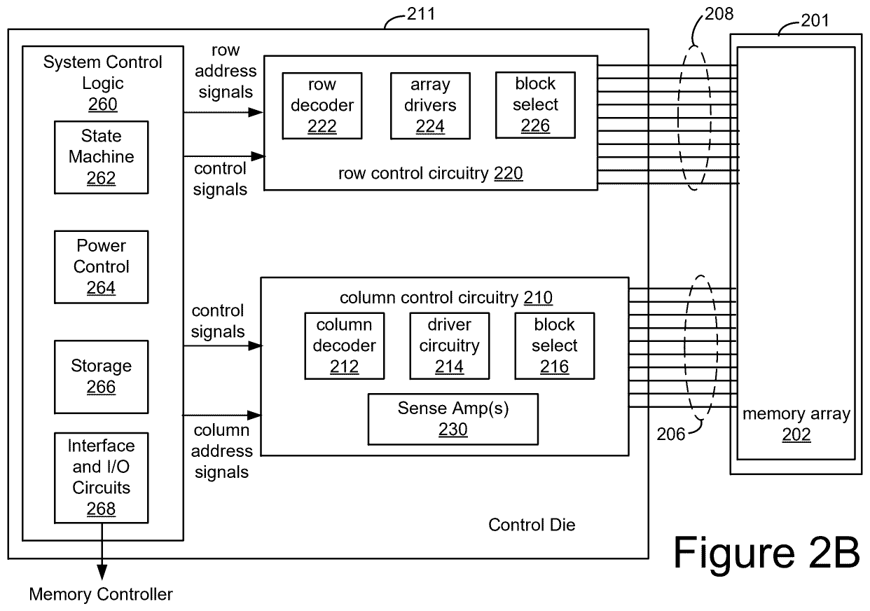

In one embodiment, non-volatile memory 130 comprises one or more memory die. FIG. 2A is a functional block diagram of one embodiment of a memory die 200 that comprises non-volatile memory 130. Each of the one or more memory die of non-volatile memory 130 can be implemented as memory die 200 of FIG. 2A. The components depicted in FIG. 2A are electrical circuits. Memory die 200 includes a memory array 202 that can comprise non-volatile memory cells, as described in more detail below. The array terminal lines of memory array 202 include the various layer(s) of word lines organized as rows, and the various layer(s) of bit lines organized as columns. However, other orientations can also be implemented. Memory die 200 includes row control circuitry 220, whose outputs 208 are connected to respective word lines of the memory array 202. Row control circuitry 220 receives a group of M row address signals and one or more various control signals from System Control Logic circuit 260, and typically may include such circuits as row decoders 222, array terminal drivers 224, and block select circuitry 226 for both reading and writing (programming) operations. Row control circuitry 220 may also include read/write circuitry. Memory die 200 also includes column control circuitry 210 including sense amplifier(s) 230 whose input/outputs 206 are connected to respective bit lines of the memory array 202. Although only single block is shown for array 202, a memory die can include multiple arrays that can be individually accessed. Column control circuitry 210 receives a group of N column address signals and one or more various control signals from System Control Logic 260, and typically may include such circuits as column decoders 212, array terminal receivers or driver circuits 214, block select circuitry 216, as well as read/write circuitry, and I/O multiplexers.

System control logic 260 receives data and commands from memory controller 120 and provides output data and status to the host. In some embodiments, the system control logic 260 (which comprises one or more electrical circuits) include state machine 262 that provides die-level control of memory operations. In one embodiment, the state machine 262 is programmable by software. In other embodiments, the state machine 262 does not use software and is completely implemented in hardware (e.g., electrical circuits). In another embodiment, the state machine 262 is replaced by a micro-controller or microprocessor, either on or off the memory chip. System control logic 262 can also include a power control module 264 that controls the power and voltages supplied to the rows and columns of the memory structure 202 during memory operations and may include charge pumps and regulator circuit for creating regulating voltages. System control logic 262 includes storage 266 (e.g., RAM, registers, latches, etc.), which may be used to store parameters for operating the memory array 202.

Commands and data are transferred between memory controller 120 and memory die 200 via memory controller interface 268 (also referred to as a “communication interface”). Memory controller interface 268 is an electrical interface for communicating with memory controller 120 and includes one or more Input/Output (“I/O”) circuits. Examples of memory controller interface 268 include a Toggle Mode Interface and an Open NAND Flash Interface (ONFI). Other I/O interfaces can also be used.

In some embodiments, all the elements of memory die 200, including the system control logic 260, can be formed as part of a single die. In other embodiments, some or all of the system control logic 260 can be formed on a different die.

In one embodiment, memory structure 202 comprises a three-dimensional memory array of non-volatile memory cells in which multiple memory levels are formed above a single substrate, such as a wafer. The memory structure may comprise any type of non-volatile memory that are monolithically formed in one or more physical levels of memory cells having an active area disposed above a silicon (or other type of) substrate. In one example, the non-volatile memory cells comprise vertical NAND strings with charge-trapping layers.

In another embodiment, memory structure 202 comprises a two-dimensional memory array of non-volatile memory cells. In one example, the non-volatile memory cells are NAND flash memory cells utilizing floating gates. Other types of memory cells (e.g., NOR-type flash memory) can also be used.

The exact type of memory array architecture or memory cell included in memory structure 202 is not limited to the examples above. Many different types of memory array architectures or memory technologies can be used to form memory structure 202. No particular non-volatile memory technology is required for purposes of the new claimed embodiments proposed herein. Other examples of suitable technologies for memory cells of the memory structure 202 include ReRAM memories (resistive random access memories), magnetoresistive memory (e.g., MRAM, Spin Transfer Torque MRAM, Spin Orbit Torque MRAM), FeRAM, phase change memory (e.g., PCM), and the like. Examples of suitable technologies for memory cell architectures of the memory structure 202 include two dimensional arrays, three dimensional arrays, cross-point arrays, stacked two dimensional arrays, vertical bit line arrays, and the like.

One example of a ReRAM cross-point memory includes reversible resistance-switching elements arranged in cross-point arrays accessed by X lines and Y lines (e.g., word lines and bit lines). In another embodiment, the memory cells may include conductive bridge memory elements. A conductive bridge memory element may also be referred to as a programmable metallization cell. A conductive bridge memory element may be used as a state change element based on the physical relocation of ions within a solid electrolyte. In some cases, a conductive bridge memory element may include two solid metal electrodes, one relatively inert (e.g., tungsten) and the other electrochemically active (e.g., silver or copper), with a thin film of the solid electrolyte between the two electrodes. As temperature increases, the mobility of the ions also increases causing the programming threshold for the conductive bridge memory cell to decrease. Thus, the conductive bridge memory element may have a wide range of programming thresholds over temperature.

Another example is magnetoresistive random access memory (MRAM) that stores data by magnetic storage elements. The elements are formed from two ferromagnetic layers, each of which can hold a magnetization, separated by a thin insulating layer. One of the two layers is a permanent magnet set to a particular polarity; the other layer's magnetization can be changed to match that of an external field to store memory. A memory device is built from a grid of such memory cells. In one embodiment for programming, each memory cell lies between a pair of write lines arranged at right angles to each other, parallel to the cell, one above and one below the cell. When current is passed through them, an induced magnetic field is created. MRAM based memory embodiments will be discussed in more detail below.

Phase change memory (PCM) exploits the unique behavior of chalcogenide glass. One embodiment uses a GeTe—Sb2Te3 super lattice to achieve non-thermal phase changes by simply changing the co-ordination state of the Germanium atoms with a laser pulse (or light pulse from another source). Therefore, the doses of programming are laser pulses. The memory cells can be inhibited by blocking the memory cells from receiving the light. In other PCM embodiments, the memory cells are programmed by current pulses. Note that the use of “pulse” in this document does not require a square pulse but includes a (continuous or non-continuous) vibration or burst of sound, current, voltage light, or another wave. These memory elements within the individual selectable memory cells, or bits, may include a further series element that is a selector, such as an ovonic threshold switch or metal insulator substrate.

A person of ordinary skill in the art will recognize that the technology described herein is not limited to a single specific memory structure, memory construction or material composition, but covers many relevant memory structures within the spirit and scope of the technology as described herein and as understood by one of ordinary skill in the art.

The elements of FIG. 2A can be grouped into two parts: (1) memory structure 202 and (2) peripheral circuitry, which includes all of the other components depicted in FIG. 2A. An important characteristic of a memory circuit is its capacity, which can be increased by increasing the area of the memory die of IPU 100 that is given over to the memory structure 202; however, this reduces the area of the memory die available for the peripheral circuitry. This can place quite severe restrictions on these elements of the peripheral circuitry. For example, the need to fit sense amplifier circuits within the available area can be a significant restriction on sense amplifier design architectures. With respect to the system control logic 260, reduced availability of area can limit the available functionalities that can be implemented on-chip. Consequently, a basic trade-off in the design of a memory die for the IPU 100 is the amount of area to devote to the memory structure 202 and the amount of area to devote to the peripheral circuitry.

Another area in which the memory structure 202 and the peripheral circuitry are often at odds is in the processing involved in forming these regions, since these regions often involve differing processing technologies and the trade-off in having differing technologies on a single die. For example, when the memory structure 202 is NAND flash, this is an NMOS structure, while the peripheral circuitry is often CMOS based. For example, elements such sense amplifier circuits, charge pumps, logic elements in a state machine, and other peripheral circuitry in system control logic 260 often employ PMOS devices. Processing operations for manufacturing a CMOS die will differ in many aspects from the processing operations optimized for an NMOS flash NAND memory or other memory cell technologies.

To improve upon these limitations, embodiments described below can separate the elements of FIG. 2A onto separately formed dies that are then bonded together. More specifically, the memory structure 202 can be formed on one die (referred to as the memory array die) and some or all of the peripheral circuitry elements, including one or more control circuits, can be formed on a separate die (referred to as the control die). For example, a memory array die can be formed of just the memory elements, such as the array of memory cells of flash NAND memory, MRAM memory, PCM memory, ReRAM memory, or other memory type. Some or all of the peripheral circuitry, even including elements such as decoders and sense amplifiers, can then be moved on to a separate control die. This allows each of the memory array die to be optimized individually according to its technology. For example, a NAND memory array die can be optimized for an NMOS based memory array structure, without worrying about the CMOS elements that have now been moved onto a control die that can be optimized for CMOS processing. This allows more space for the peripheral elements, which can now incorporate additional capabilities that could not be readily incorporated were they restricted to the margins of the same die holding the memory cell array. The two die can then be bonded together in a bonded multi-die memory circuit, with the array on the one die connected to the periphery elements on the other die. Although the following will focus on a bonded memory circuit of one memory array die and one control die, other embodiments can use more die, such as two memory array die and one control die, for example.

FIG. 2B shows an alternative arrangement to that of FIG. 2A which may be implemented using wafer-to-wafer bonding to provide a bonded die pair. FIG. 2B depicts a functional block diagram of one embodiment of an integrated memory assembly 207, which is another example of a memory die. One or more integrated memory assemblies (one or more memory die) 207 may be used to implement the non-volatile memory 130 of IPU 100. The integrated memory assembly (or memory die) 207 includes two types of semiconductor die (or more succinctly, “die”). Memory array die 201 includes memory structure 202. Memory structure 202 includes non-volatile memory cells. Control die 211 includes control circuitry 260, 210, and 220 (as described above). In some embodiments, control die 211 is configured to connect to the memory structure 202 in the memory array die 201. In some embodiments, the memory array die 201 and the control die 211 are bonded together.

FIG. 2B shows an example of the peripheral circuitry, including control circuits, formed in a peripheral circuit or control die 211 coupled to memory structure 202 formed in memory array die 201. Common components are labelled similarly to FIG. 2A. System control logic 260, row control circuitry 220, and column control circuitry 210 are located in control die 211. In some embodiments, all or a portion of the column control circuitry 210 and all or a portion of the row control circuitry 220 are located on the memory array die 201. In some embodiments, some of the circuitry in the system control logic 260 is located on the on the memory array die 201.

System control logic 260, row control circuitry 220, and column control circuitry 210 may be formed by a common process (e.g., CMOS process), so that adding elements and functionalities, such as ECC, more typically found on a memory controller 120 may require few or no additional process steps (i.e., the same process steps used to fabricate controller 120 may also be used to fabricate system control logic 260, row control circuitry 220, and column control circuitry 210). Thus, while moving such circuits from a die such as memory 2 die 201 may reduce the number of steps needed to fabricate such a die, adding such circuits to a die such as control die 211 may not require many additional process steps. The control die 211 could also be referred to as a CMOS die, due to the use of CMOS technology to implement some or all of control circuitry 260, 210, 220.

FIG. 2B shows column control circuitry 210 including sense amplifier(s) 230 on the control die 211 coupled to memory structure 202 on the memory array die 201 through electrical paths 206. For example, electrical paths 206 may provide electrical connection between column decoder 212, driver circuitry 214, and block select 216 and bit lines of memory structure 202. Electrical paths may extend from column control circuitry 210 in control die 211 through pads on control die 211 that are bonded to corresponding pads of the memory array die 201, which are connected to bit lines of memory structure 202. Each bit line of memory structure 202 may have a corresponding electrical path in electrical paths 206, including a pair of bond pads, which connects to column control circuitry 210. Similarly, row control circuitry 220, including row decoder 222, array drivers 224, and block select 226 are coupled to memory structure 202 through electrical paths 208. Each of electrical path 208 may correspond to a word line, dummy word line, or select gate line. Additional electrical paths may also be provided between control die 211 and memory array die 201.

For purposes of this document, the phrases “a control circuit” or “one or more control circuits” can include any one of or any combination of memory controller 120, state machine 262, all or a portion of system control logic 260, all or a portion of row control circuitry 220, all or a portion of column control circuitry 210, a microcontroller, a microprocessor, and/or other similar functioned circuits. The control circuit can include hardware only or a combination of hardware and software (including firmware). For example, a controller programmed by firmware to perform the functions described herein is one example of a control circuit. A control circuit can include a processor, FPGA, ASIC, integrated circuit, or other type of circuit.

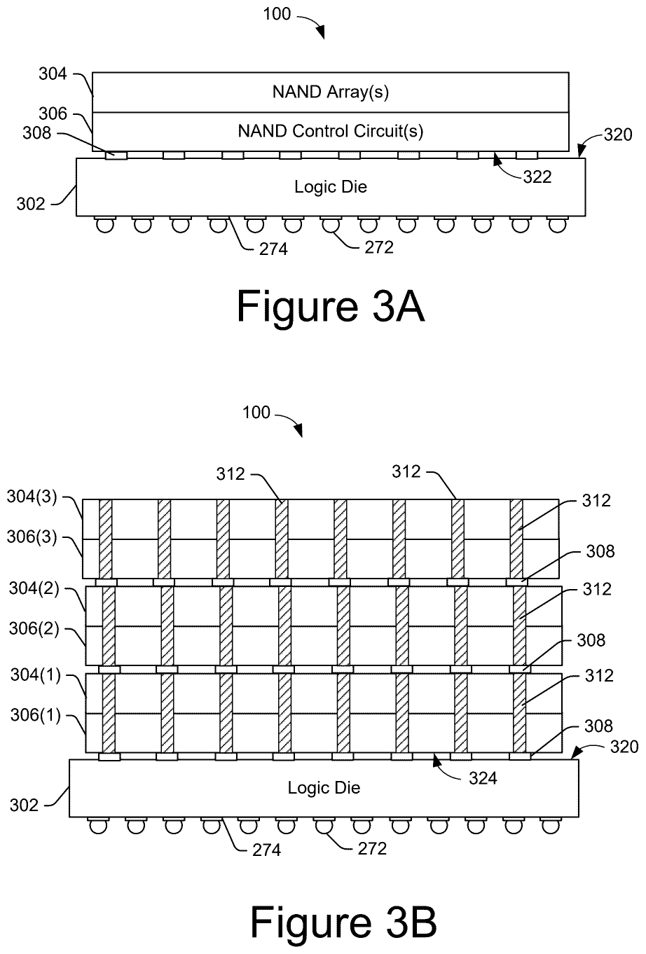

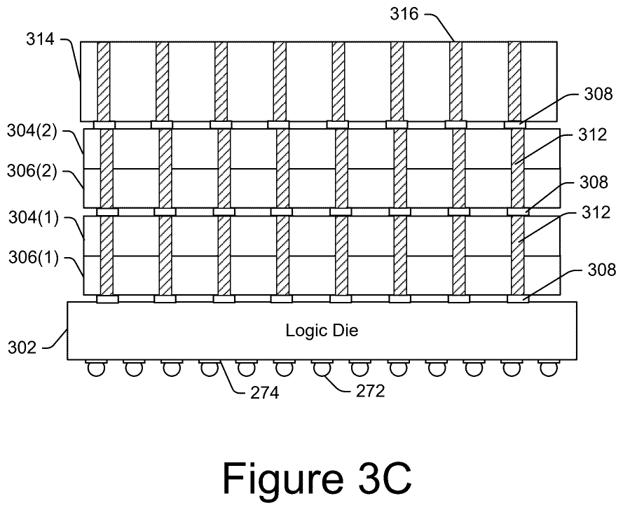

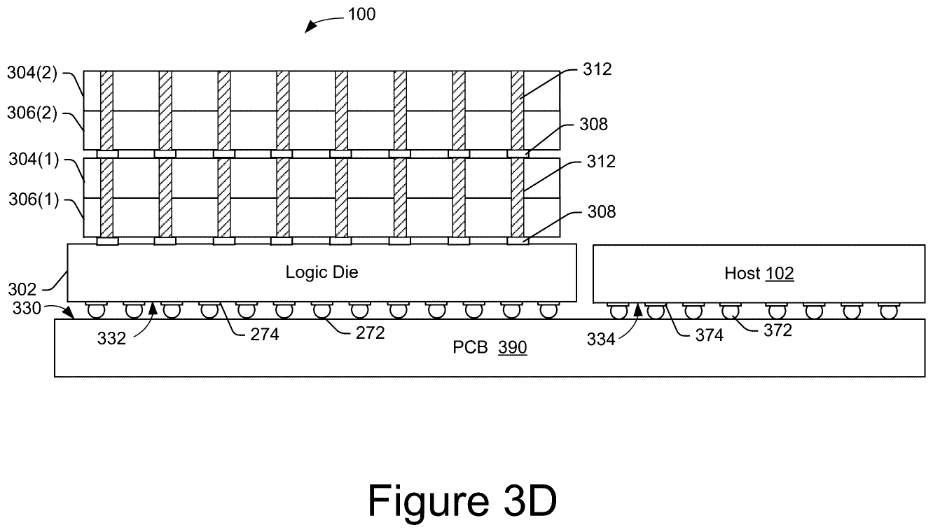

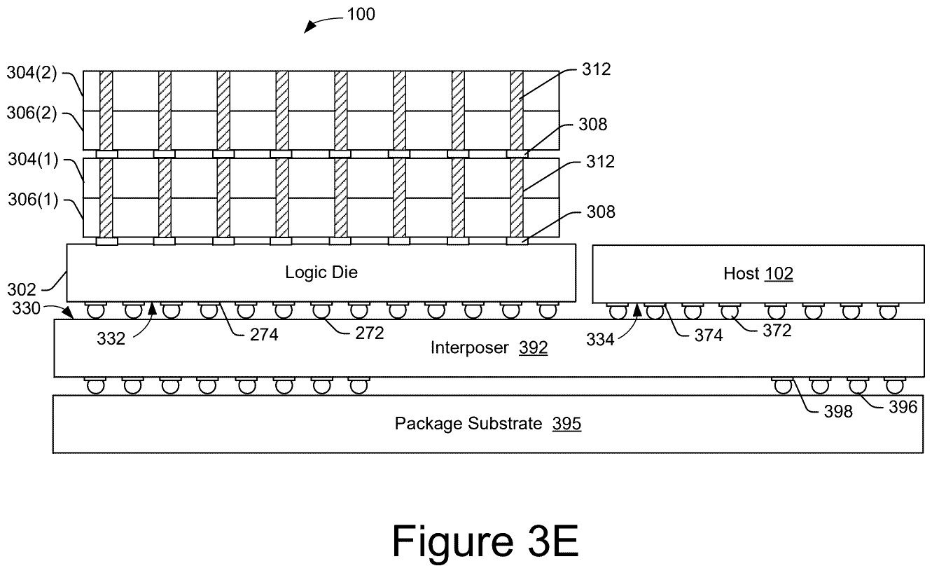

An embodiment includes an IPU 100 having a logic die and one or more NAND memory arrays. FIG. 3A shows a side view of one embodiment of an IPU 100 having a logic die 302, NAND array(s) 304, and a NAND control circuit 306. In an embodiment, NAND array(s) 304 and NAND control circuit 306 are implemented by memory die 200. NAND array(s) 304 may be implemented in memory array 202 and NAND control circuit 306 may be implemented by the combination of system control logic 260, row control circuitry 220, and column control circuitry 210. In an embodiment, NAND array(s) 304 is implemented by memory array die 201 and NAND control circuit 306 is implemented by control die 211.

The logic die 302 contains one or more ECC engines 158 and one or more inference engines 162. In an embodiment, the logic die 302 implements the memory controller 120 of FIG. 1B. Microbumps 308 may be used to provide electrical connections between the NAND control circuit 306 and the logic die 302. An upper surface 320 of the logic die 302 opposes a lower surface 322 of the NAND control circuits 306. The upper surface 320 of the logic die 302 may be connected to the lower surface 322 of the NAND control circuit 306 by surface connections such as the microbumps 308. Significantly, no interposer is needed between the logic die 302 and the NAND control circuit 306 (or the NAND array(s) 304).

In an embodiment, the logic die 302 resides on a substrate (e.g., PCB board). The substrate is not depicted in FIG. 3A. Solder balls 272 may optionally be affixed to contact pads 274 on a lower surface of logic die 302. The solder balls 272 may be used to couple the logic die 302 electrically and mechanically to a substrate such as a printed circuit board. Significantly, the logic die 302 is not required to have through silicon vias (TSVs) to allow communication with the NAND control circuit 306 or to access the NAND array 304.

FIG. 3A shows an embodiment in which there is a single layer having a NAND array 304 and NAND control circuit 306. In an embodiment in which memory die 200 has the NAND array(s) 304 and NAND control circuit(s) 306, the layer may contain one or more memory dies. For example, there may two memory dies 200, four memory dies 200, etc. In an embodiment in which memory array die 201 has the NAND array(s) 304 and the control die 211 has the NAND control circuit(s) 306, there may be one or more memory array dies 201 and one or more control dies 211. The number of control dies 211 in a layer is not required to be equal to the number of memory array dies 201 in that layer. For example, one control die 211 may be used to control more than one memory array die 201 in a layer.

Some embodiments of an IPU 100 include a stack that contains a number of layers, with each layer having one or more NAND arrays and associated NAND control circuitry. FIG. 3B shows a side view of one embodiment in which the IPU 100 has a stack with three layers. A first layer includes NAND array(s) 304(1) and associated NAND control circuitry 306(1). A second layer includes NAND array(s) 304(2) and associated NAND control circuitry 306(2). A third layer includes NAND array(s) 304(3) and associated NAND control circuitry 306(3). There could be more or fewer than three layers in the stack. The discussion of the single layer in FIG. 3A applied to each layer in FIG. 3B. Thus, the architecture in FIG. 2A and/or 2B may be used in the IPU 100 in FIG. 3B. An upper surface 320 of the logic die 302 opposes a lower surface 324 of the NAND control circuits 306. The upper surface 320 of the logic die 302 may be directly connected to the lower surface 324 of the stack by surface connections such as the microbumps 308. Significantly, no interposer is needed between the logic die 302 and the stack.

Through silicon vias (TSV) 312 may be used to route signals through the stack. For example, TSVs 312 may be used to route signals through memory dies 200, memory array dies 201 and/or control dies 211 in the stack. The TSVs from the various die of the stack can be separately operated such that the logic die 302 can communicate with each die separately. The TSVs 312 may be formed before, during or after formation of the integrated circuits in the semiconductor dies (e.g., memory dies 200, memory array dies 201 and/or control dies 211). The TSVs may be formed by etching holes through the wafers. The holes may then be lined with a barrier against metal diffusion. The barrier layer may in turn be lined with a seed layer, and the seed layer may be plated with an electrical conductor such as copper, although other suitable materials such as aluminum, tin, nickel, gold, doped polysilicon, and alloys or combinations thereof may be used. Note that the logic die 302 is not required to have TSVs. Since TSVs may occupy considerable area, the size of the logic die 302 may be reduced as it does not need TSVs. This savings in chip area may be used to add more circuitry such as inference engines and ECC engines.

In one embodiment, the stack in the IPU 100 contains DRAM. FIG. 3C shows a side view of an IPU having both NAND memory and DRAM. The IPU 100 in FIG. 3C has a logic die 302 and two layers of NAND (NAND circuitry 306(1) and NAND memory 304(1) in a first layer and NAND circuitry 306(2) and NAND memory 304(2) in a second layer). The third layer contains DRAM 314. The DRAM 314 may have TSVs 316 to allow communication with the logic die 302. The DRAM 314 may be located at any level of the stack.

FIG. 3D shows a side view of one embodiment of a system having an IPU 100 and a host 102. The host 102 may be, for example, a CPU, GPU, etc. The host 102 and the IPU 100 reside on a printed circuit board (PCB) 390. FIG. 3D shows a sideview of one embodiment of one of the IPUs 100 and the host 102 of FIG. 1A. Thus, although only one IPU 100 is depicted in FIG. 3D, there may be other IPUs 100 on the PCB 390. The logic die 302 has contact pads 274 on a lower surface 332 of the logic die 302. Solder balls 272 may be used to couple the logic die 302 electrically and mechanically to an upper surface 330 the PCB 390. The host 102 has contact pads 374 on a lower surface 334 of the host 102. Solder balls 372 may be used to couple the host 102 electrically and mechanically to the PCB 390. The logic die 302 is connected to the host 102 over a communication interface (not depicted in FIG. 3D, but see communication interface 14 in FIG. 1A). The electrical connections between the host 102 and the IPU 100 may be made by, for example, PCB traces. In this embodiment the system does not need an interposer between the host 102 and the IPU 100. Moreover, the system does not need any interposers within the IPU 100.

FIG. 3E shows a side view of one embodiment of a system having an IPU 100 and a host 102. The host 102 may be a CPU, GPU, etc. The host 102 and the IPU 100 reside on an interposer 392. An interposer, which is known in the art, is a component used in electronics and semiconductor manufacturing to facilitate connections between different components or technologies that might not naturally interface with each other due to differences in form factor, electrical specifications, or other factors. The interposer may include an electrical interface for routing between the host 102 and IPU 100. The interposer may also include an electrical interface for routing between the host 102 and package substrate 395, as well as an electrical interface for routing between the logic die 302 and package substrate 395. In some cases, the purpose of an interposer is to spread a connection to a wider pitch or to reroute a connection to a different connection. FIG. 3E shows a sideview of one embodiment of one of the IPUs 100 and the host 102 of FIG. 1A. Thus, although only one IPU 100 is depicted in FIG. 3E, there may be other IPUs 100 on the interposer 392. The logic die 302 has contact pads 274 on a lower surface 332 of the logic die 302. Solder balls 272 may be used to couple the logic die 302 electrically and mechanically to an upper surface 330 the interposer 392. The host 102 has contact pads 374 on a lower surface 334 of the host 102. Solder balls 372 may be used to couple the host 102 electrically and mechanically to the interposer 392. The interposer 392 has contact pads 398 and solder balls 396 to connect physically and electrically to the package substate 395. The logic die 302 is connected to the host 102 over a communication interface (not depicted in FIG. 3E, but see communication interface 14 in FIG. 1A). The electrical pathways of the communication interface may pass through the interposer 392, as is known to those of ordinary skill in the art. Although the system in FIG. 3E has an interposer 392 between the IPU 100 and the host 102, no interposer is needed in the IPU 100.

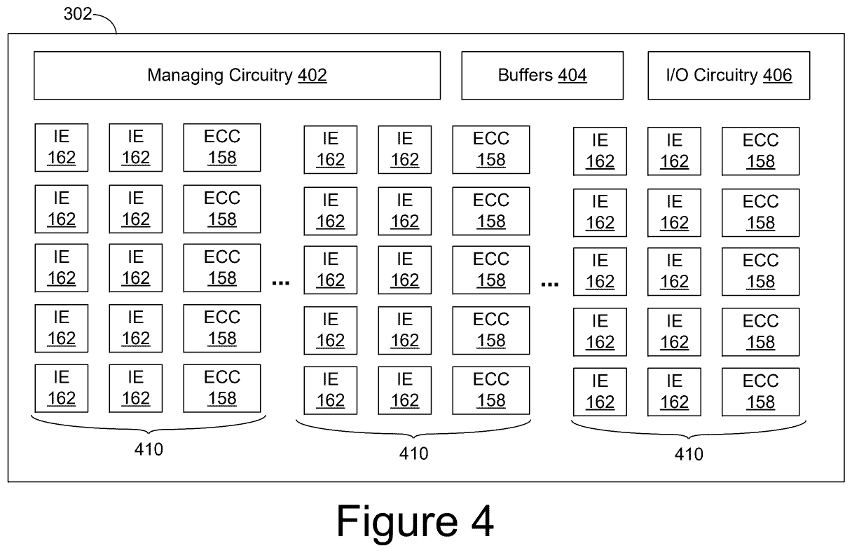

FIG. 4 is a block diagram of one embodiment of a logic die 302 that is included in an embodiment of an IPU. The logic die 302 has a number of ECC circuits 158 and a number of inference engines (IE) 162. In one embodiment, each IE 162 is used for computations in one of the layers of a neural network. The organization in FIG. 4 may thus be viewed as being organized based on a number of layers 410 of a neural network. However, other configurations for the IEs 162 may be used. In one possible configuration each ECC circuit 158 is associated with one or more IEs 162 such that the ECC circuit 158 provides decoded data to one or more IEs 162. In the example in FIG. 4, each ECC 158 is associated with two IEs 162 (to the left of the ECC 158); however, this is just one possible configuration. In general, each ECC 158 is associated with one or more IEs 162. The logic die 302 also has managing circuitry 402, buffers 404, and I/O circuitry 406. The managing circuitry 402 oversees the transfer of data to and from the non-volatile memory (e.g., NAND). The I/O circuitry 406 is used to transfer data to the non-volatile memory and to receive data from the non-volatile memory. The buffers 404 may be used to buffer data prior to sending to the non-volatile memory and after receiving the data from the non-volatile memory. The managing circuitry 402 provides data from the buffers 404 to the appropriate ECC engine 158. This data may include, but is not limited to, parameters (e.g., weights) of AI model or intermediate results from one of the layers 410. For example, intermediate results from one layer 410 may be temporarily stored in the non-volatile memory and then read back for use by another layer 410.

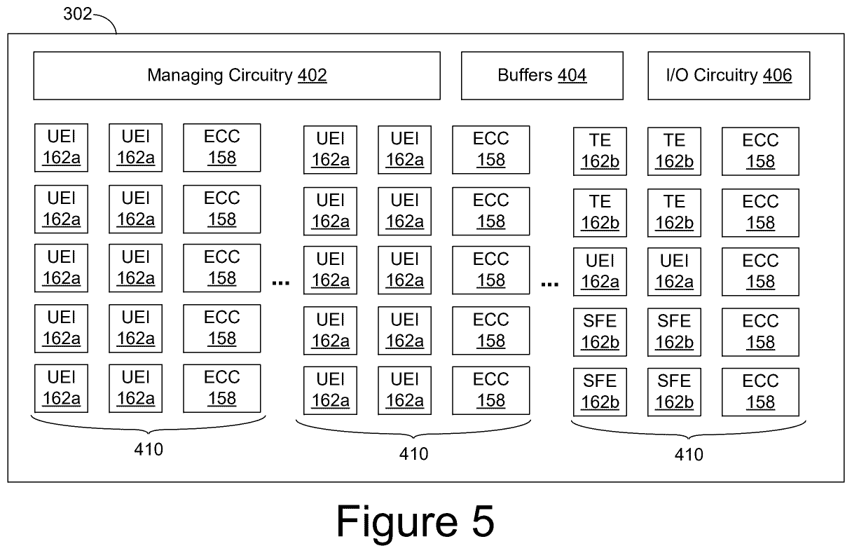

In an embodiment, each of the IEs 162 on the logic die 302 in FIG. 4 are uniform. Multiple uniform inference engines can help achieve parallel computation during inference. In an embodiment, different type of compute engines are provided. FIG. 5 is a block diagram of another embodiment of a logic die 302. In addition to the normal inference engines (UIE) 162a, there are tensor engines (TE) 162b and sparsity-friendly engines (SPE) 162c. The additional engines address issues of computational power underutilization for sparse or mixed-precision data.

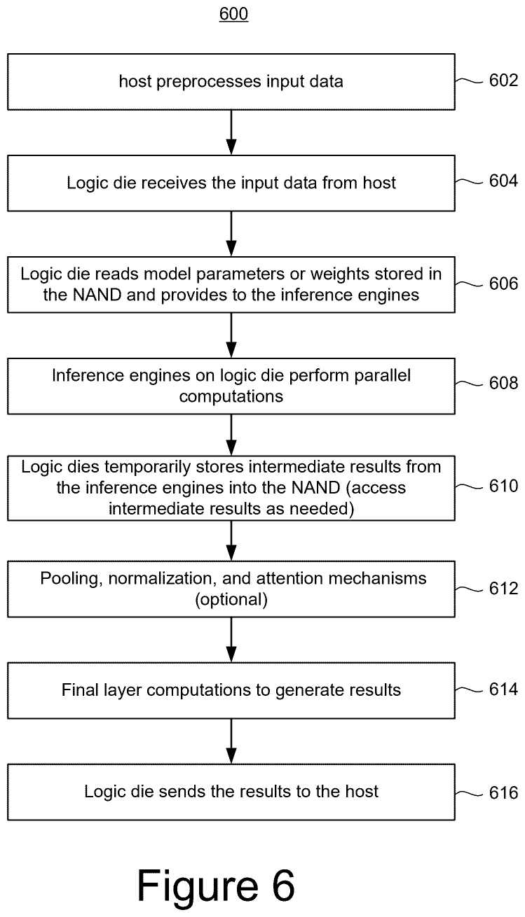

FIG. 6 is a flowchart of one embodiment of a process 600 of performing inferencing using high bandwidth non-volatile memory (e.g., NAND) with near memory compute. The process 600 may be performed in a system such as the system of FIG. 1A or 1B. Various steps in process 600 are performed in an IPU such as, but not limited to, those depicted in FIGS. 3A, 3B, 3C, 3D, 3E. Process 600 is described with respect to one IPU 100, but may be performed in parallel with a number of IPUs 100. Inference models, especially large deep learning models, consist of many parameters or weights. Steps in process 600 are described in a certain order for convenience of discussion. The steps may occur in a different order. It will be understood by those of ordinary skill in the art that some steps may be repeated. Prior to performing process 600 the logic die 302 of the IPU 100 stores parameters (e.g., weights) of an AI model in the non-volatile memory 130 (e.g., NAND array(s) 304).

Step 602 includes the host 102 (e.g., CPU, GPU, etc.) preprocessing input data. The input data may include, for example, images, text, sensor data, etc. The preprocessing may include, for example, normalization, resizing, or tokenization to convert raw data into a format suitable for the AI model.

Step 604 includes the logic die 302 of the IPU 100 receiving the input data from the host 102. In an embodiment, the IPU 100 and host 102 reside on the same surface of a PCB 390 such that no interposer is needed between the IPU 100 and the host 102. However, the IPU 100 and host 102 may reside on an interposer 392. However, an interposer is not required within the IPU 100. For example, an interposer is not required between the logic die 302 and stack of memory dies.

Step 606 includes the logic die 302 reading the parameters (e.g., weights) of the AI model that were previously stored in the NAND. The parameters (e.g., weights) are provided to the inference engines 162. These parameters (e.g., weights) may be read from the NAND with low latency. Step 606 may also include providing the input data to the inference engines.

Step 608 includes the inference engines 162 on the logic die 302 performing parallel computations. Each inference engine 162 is able to handle a part of the computation. Example computations include, but are not limited to matrix multiplications and convolutions. The IPU 100 with inference engines 162 provides for a highly parallelized architecture.

Step 610 includes the logic die 302 temporarily storing intermediate results from the inference engines 162 to the NAND (or other non-volatile memory). These intermediate results are accessed as needed. For example, results from one layer may be temporarily stored in the NAND and accessed as needed for another layer. Step 610 allows for quick access by subsequent layers, as many deep learning models involve dozens to hundreds of stacked layers. Step 610 may include storing results from activation functions. After matrix operations, the inferences engines 162 may apply non-linear activation functions (e.g., ReLU, Sigmoid) to intermediate outputs. These intermediate results (e.g., activations) may be stored to NAND in step 610.

Step 612 optionally includes pooling, normalization, and attention mechanisms. The pooling, normalization, and attention mechanisms are optional operations depending on the model. For models that include pooling layers (to down-sample feature maps), normalization (to stabilize activations), or attention mechanisms (for focusing on specific input features), the inference engines 162 perform these operations in parallel in step 612. The NAND's bandwidth supports these additional operations by allowing fast access to intermediate layer outputs (e.g., KV caches) as needed. In an embodiment, the stack of memory dies in the IPU 100 has at least one DRAM die 314 (see FIG. 3C). In an embodiment, the DRAM die 314 is used for KV caches, which may need to be accessed quite frequently.

Step 614 includes final layer computations to generate inference results. In the final layer(s), the inference engine computes the model's predictions, such as class probabilities in classification tasks or bounding boxes in object detection tasks. Step 614 may include additional matrix multiplications and transformations based on the model's output format. The results may be stored in the NAND in the IPU 100.

Step 616 includes the logic die 302 sending the inference results (e.g., predicted classes, probabilities) to the host 102. The host 102 may then process the results or send the results to downstream systems.

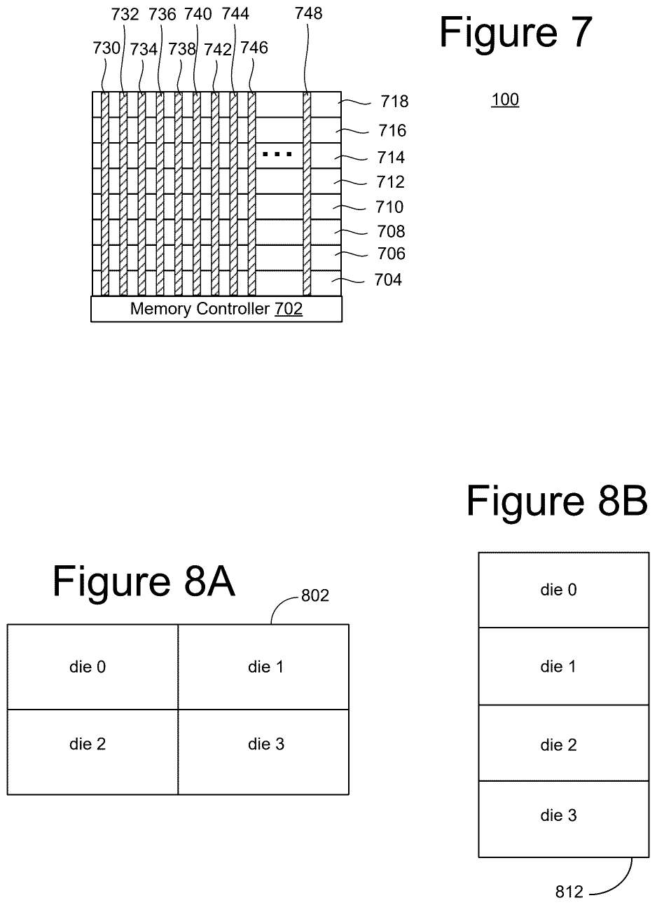

FIG. 7 depicts one embodiment of a non-volatile IPU 100 capable of performing a high bandwidth read of non-volatile memory. IPU 100 includes a stack of memory dies. The stack of memory dies comprises multiple layers; for example, FIG. 7 depicts eight layers: 704, 706, 708, 710,712, 714, 716 and 718. In other embodiments, more or fewer than eight layers can be included. Each layer may comprise multiple memory die. Below the eight layers 704-718 is Memory Controller 702. In one embodiment, Memory Controller 702 implements the structure of Memory Controller 120 of FIG. 1B, while in other embodiments different architectures can be used for the memory controller.

The stack of memory dies comprising the eight layers 704-718 includes a plurality of TSVs. FIG. 7 depicts TSVs 730, 732, 734, 736, 738, 740, 742, 744, 746, . . . 748. In one embodiment, each memory die includes its own separate set of TSVs that are used to communicate with Memory Controller 702 and each memory die's separate set of TSVs run parallel to other memory die's separate set of TSVs to form parallel paths (separate parallel TSV's) to/from Memory Controller 702. All of the TSVs of each of the memory die of the eight layers 704-718 connect to Memory Controller 702 for purposes of routing the electrical signals between the TSVs of each of the memory dies of the eight layers 704-718 and Memory Controller 702. In this manner, Memory Controller 702 can perform a high bandwidth read process for data stored in the stack across all or multiple of the memory dies of layers 704-718.

Note that an interposer is not required between the memory controller 702 and the stack of memory dies. An interposer, which is known in the art, is a component used in electronics and semiconductor manufacturing to facilitate connections between different components or technologies that might not naturally interface with each other due to differences in form factor, electrical specifications, or other factors. An interposer is an electrical interface routing between connection to another. In some cases, the purpose of an interposer is to spread a connection to a wider pitch or to reroute a connection to a different connection.

FIG. 8A is a block diagram of one layer 802 of layers 704-718. Layer 802 can be used to implement any layer of or all layers of layers 704-718. Layer 802 includes four memory dies: die 0, die 1, die 2 and die 3. Each of those memory dies (die 0, die 1, die 2 and die 3) can be based on the structure of FIG. 2A, the structure of FIG. 2B or a different structure for a non-volatile memory die. As will be discussed in more detail below, each memory die comprises multiple planes (arrays), groups of planes form banks, each memory die has multiple I/O circuits such that there is one I/O circuit per bank, and the separate parallel TSV's (e.g., 730-748) comprise separate parallel TSV's for each I/O circuit of each memory die.

FIG. 8B is a block diagram of another embodiment of one layer of layers 704-718. Layer 812 of FIG. 8B can be used to implement any layer of or all layers of layers 704-718. Layer 812 includes four memory dies: die 0, die 1, die 2 and die 3. Each of those memory dies (die 0, die 1, die 2 and die 3) can be based on the structure of FIG. 2A, the structure of FIG. 2B or a different structure for a non-volatile memory die.

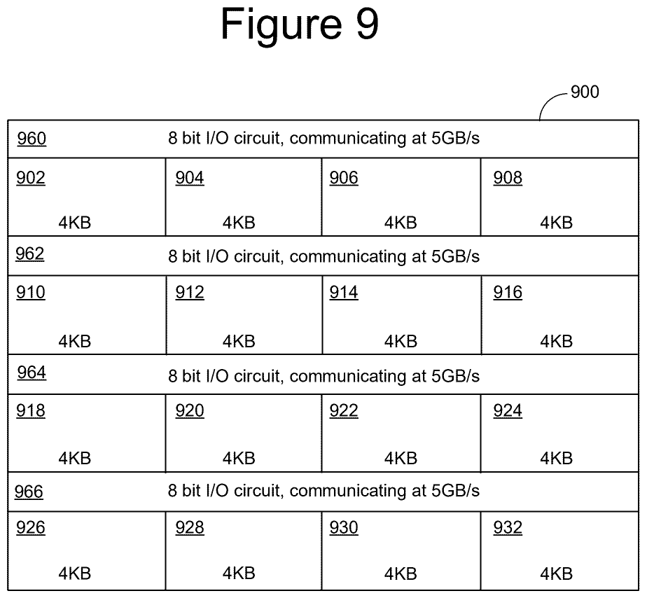

FIG. 9 is a block diagram depicting one embodiment of a partial floorplan for a memory die 900 (i.e., looking down at the memory die). In one embodiment, memory die 900 can implement the structure of FIG. 2A, the structure of FIG. 2B or a different structure for a non-volatile memory die. Memory die 900 is an example of a memory die that can be used on each of layers 704-718 depicted in FIG. 7. That is, memory die 900 can be used to implement memory die 0, memory die 1, memory die 2 and memory die 3 of FIGS. 8A and 8B for any or all of layers 704-718. Memory die 900 includes sixteen planes: 902, 904, 906, 908,910, 912, 914, 916, 918, 920, 922, 924, 926, 928, 930 and 932. Each plane is divided into pages of 4K Bytes. The planes are grouped into banks and memory die 900 includes one I/O circuit per bank. In one embodiment, there are four banks for memory die 900. The first bank comprises planes 902, 904, 906 and 908, and is connected to (and uses) I/O circuit 960. That means that data programmed into or read from planes 902, 904, 906 and 908 is communicated between memory die 900 and Memory Controller 702 via I/O circuit 960. The second bank comprises planes 910, 912, 914, and 916, and is connected to (and uses) I/O circuit 962. That means that data programmed into or read from planes 910, 912, 914, and 916 is communicated between memory die 900 and Memory Controller 702 via I/O circuit 962. The third bank comprises planes 918, 920, 922, and 924, and is connected to (and uses) I/O circuit 964. That means that data programmed into or read from planes 918, 920, 922, and 924 is communicated between memory die 900 and Memory Controller 702 via I/O circuit 964. The fourth bank comprises planes 926, 928, 930 and 932, and is connected to (and uses) I/O circuit 966. That means that data programmed into or read from planes 926, 928, 930 and 932 is communicated between memory die 900 and Memory Controller 702 via I/O circuit 966.

I/O circuits 960, 962, 964 and 966 each implement a separate eight bit data bus and are able to communicate at 5 Giga Bytes (“GB”) per second. The eight bit data bus is implemented as eight TSVs (see e.g., TSVs 730-748). Since there are four I/O circuits in memory die 900, then memory die 900 needs thirty two TSVs. In one embodiment, I/O circuits 960, 962, 964 and 966 are part of Interface and I/O circuits 268 of FIG. 2A or 2B. In one embodiment, I/O circuits 960, 962, 964 and 966 further comprise input and output drivers (large out drivers with many stages to enable the I/O driving few pF load) and clocking to track the data.

In one embodiment, memory die 900 can sense data in 3.2 μs and 64 KB can be sensed at the same time (4 KB page×16 planes). Therefore, memory die 900 can sense 21 GB per second. Since the four I/O circuits of memory die 900 each transmit eight bits at 5 GB per second, the memory die can transfer 20 GB of sensed data per second, which is slightly slower than the sensing speed of 21 GB per second. Since there are four memory die on a layer (e.g., layer 802 of FIG. 8), each layer can transmit 80 GB per second. Since there are eight layers (see layers 704-718 of FIG. 7), the memory system of FIG. 7 can transmit 640 GB per second when implementing memory die 900. Since the I/O circuitry for each bank may be operated separately and independently, the I/O circuitry may be used for parallel transmission of data that was read in different planes.

Looking back at FIG. 7, to implement four memory dies 900 on a level requires 32 TSVs for each of the four memory dies, for a total of 128 TSVs for each level. Since there are memory dies on eight layers (e.g., layers 704-718) then 1024 TSVs are needed (32 TSVs per memory die×32 memory die). These 1024 TSVs are not connected to each other (e.g., no memory die's I/O is connected to another memory die's I/O), rather they are in parallel to each other and all connect to Memory Controller 702. In this manner, a read process can be performed that delivers 640 GB of data per second to Memory Controller 702.

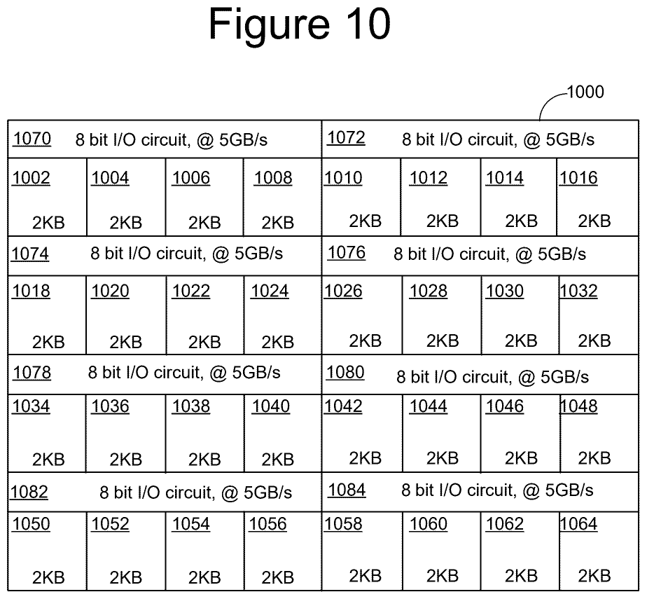

FIG. 10 is a block diagram depicting another embodiment of a partial floorplan for a memory die 1000 (i.e., looking down at the memory die). In one embodiment, memory die 1000 can implement the structure of FIG. 2A, the structure of FIG. 2B or a different structure for a non-volatile memory die. Memory die 1000 is an example of a memory die that can be used on each of layers 704-718 depicted in FIG. 7. That is, memory die 1000 can be used to implement die 0, die 1, die 2 and die 3 of FIGS. 8A and 8B for any or all of layers 704-718. Memory die 1000 includes thirty two planes: 1002, 1004, 1006, 1008, 1010, 1012, 1014, 1016, 1018, 1020, 1022, 1024, 1026, 1028, 1030, 1032, 1034, 1036, 1038, 1040, 1042, 1044, 1046, 1048, 1050, 1052, 1054, 1056, 1058, 1060, 1062 and 1064. Each plane is divided into pages of 2K Bytes in this example. The page sizes may be larger or smaller than 2K Bytes.

The planes are grouped into banks and memory die 1000 includes one I/O circuit per bank. In one embodiment, there are eight banks for memory die 1000. The first bank comprises planes 1002-1008, and is connected to (and uses) I/O circuit 1070. That means that data programmed into or read from planes 1002-1008 is communicated between memory die 1000 and Memory Controller 702 via I/O circuit 1070. The second bank comprises planes 1010-1016, and is connected to (and uses) I/O circuit 1074. That means that data programmed into or read from planes 1010-1016 is communicated between memory die 1000 and Memory Controller 702 via I/O circuit 1072. The third bank comprises planes 1018-1024, and is connected to (and uses) I/O circuit 1074. That means that data programmed into or read from planes 1018-1024 is communicated between memory die 1000 and Memory Controller 702 via I/O circuit 1074. The fourth bank comprises planes 1026-1032, and is connected to (and uses) I/O circuit 1076. That means that data programmed into or read from planes 1026-1032 is communicated between memory die 1000 and Memory Controller 702 via I/O circuit 1076. The fifth bank comprises planes 1034-1040, and is connected to (and uses) I/O circuit 1078. That means that data programmed into or read from planes 1034-1040 is communicated between memory die 1000 and Memory Controller 702 via I/O circuit 1078. The sixth bank comprises planes 1042-1048, and is connected to (and uses) I/O circuit 1080. That means that data programmed into or read from planes 1042-1048 is communicated between memory die 1000 and Memory Controller 702 via I/O circuit 1080. The seventh bank comprises planes 1050-1056, and is connected to (and uses) I/O circuit 1082. That means that data programmed into or read from planes 1050-1056 is communicated between memory die 1000 and Memory Controller 702 via I/O circuit 1082. The eighth bank comprises planes 1058-1064, and is connected to (and uses) I/O circuit 1084. That means that data programmed into or read from planes 1058-1064 is communicated between memory die 1000 and Memory Controller 702 via I/O circuit 1084.

I/O circuits 1070, 1072, 1074, 1076, 1078, 1080, 1082 and 1084 each implement a separate eight bit data bus and are able to communicate at 5 GB per second. The eight bit data bus is implemented as eight TSVs (see e.g., TSVs 730-748). Since there are eight I/O circuits in memory die 1000, then memory die 1000 needs sixty four TSVs for transmitting sixty four bits. In one embodiment, I/O circuits 1070, 1072, 1074, 1076, 1078, 1080, 1082 and 1084 are part of Interface and I/O circuits 268 of FIG. 2A or 2B. In one embodiment, I/O circuits 1070, 1072, 1074, 1076, 1078, 1080, 1082 and 1084 further comprise input and output drivers (large output drivers with many stages to enable the I/O driving few pF load) and clocking to track the data.

In one embodiment, memory die 1000 can sense data in 1.6 s and 64 KB can be sensed at the same time (2 KB page×32 planes). The sensing time is shorter for memory die 1000 as compared to memory die 900 due to the smaller page size resulting in shorter word lines and, thus, smaller RC delays. Therefore, memory die 1000 can sense 40 GB per second. Since the eight I/O circuits of memory die 1000 each transmit eight bits at 5 GB per second, the memory die can transfer 40 GB of sensed data per second. Since there are four memory die on a layer (e.g., layer 802 of FIG. 8), each layer can transmit 160 GB per second. Since there are eight layers (see layers 704-718 of FIG. 7), the memory system of FIG. 7 can transmit 1280 GB per second when implementing memory die 1000. Thus, the embodiment of FIG. 10 has twice the bandwidth of the embodiment of FIG. 9.

To implement four memory dies 1000 on a level requires 64 TSVs for each of the four memory dies, for a total of 256 TSVs (for 256 bits of data) for each level. Since there are memory dies on eight layers (e.g., layers 704-718) then 2048 TSVs are needed (64 TSVs per memory die×32 memory die). These 2048 TSVs are not connected to each other (e.g., no memory die's I/O is connected to another memory die's I/O), rather they are in parallel to each other and all connect to Memory Controller 702. In this manner, a read process can be performed that delivers 1280 GB of data per second to Memory Controller 702.

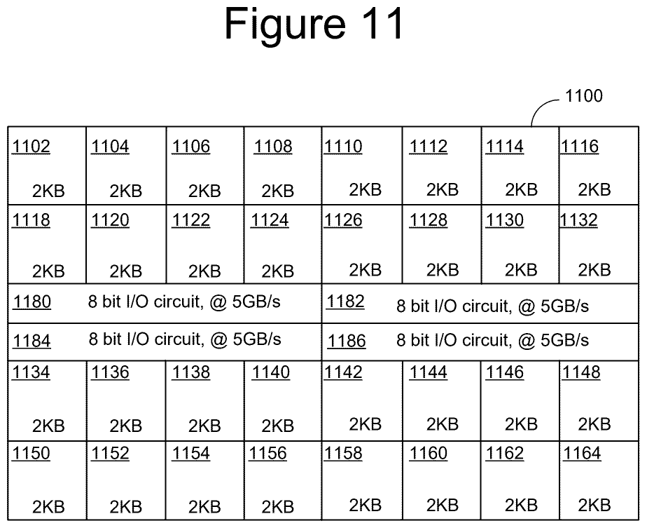

FIG. 11 is a block diagram depicting another embodiment of a partial floorplan for a memory die 1100 (i.e., looking down at the memory die). In one embodiment, memory die 1100 can implement the structure of FIG. 2A, the structure of FIG. 2B or a different structure for a non-volatile memory die. Memory die 1100 is an example of a memory die that can be used on each of layers 704-718 depicted in FIG. 7. That is, memory die 1100 can be used to implement die 0, die 1, die 2 and die 3 of FIGS. 8A and 8B for any or all of layers 704-718. Memory die 1100 includes thirty two planes: 1102, 1104, 1106, 1108, 1110, 1112, 1114, 1116, 1118, 1120, 1122, 1124, 1126, 1128, 1130, 1132, 1134, 1136, 1138, 1140, 1142, 1144, 1146, 1148, 1150, 1152, 1154, 1156, 1158, 1160, 1162 and 1164. Each plane is divided into pages of 2K Bytes. In one embodiment, a page is the unit of reading and/or programming, while a block is the unit of erase.

The planes are grouped into banks and memory die 1100 includes one I/O circuit per bank. In one embodiment, there are four banks for memory die 1100. The first bank comprises planes 1102, 1104, 1106, 1108, 1118, 1120, 1122 and 1124 and is connected to (and uses) I/O circuit 1080. The second bank comprises planes 1110, 1112, 1114, 1116, 1126, 1128, 1130 and 1132, and is connected to (and uses) I/O circuit 1182. The third bank comprises planes 1134, 1136, 1138, 1140, 1150, 1152, 1154 and 1156, and is connected to (and uses) I/O circuit 1184. The fourth bank comprises planes 1142, 1144, 1146, 1148, 1158, 1160, 1162, and 1164, and is connected to (and uses) I/O circuit 1186.

I/O circuits 1180, 1182, 1184, and 1186 each implement a separate eight bit data bus and are able to communicate at 5 GB per second. The eight bit data bus is implemented as eight TSVs (see e.g., TSVs 730-748). Since there are four I/O circuits in memory die 1100, then memory die 1100 needs thirty two TSVs for transmitting thirty two bits. Note that in the embodiments of FIGS. 9 and 10, the I/O circuits are dispersed in the memory die adjacent respective banks, while in the embodiment of FIG. 11 the I/O circuits are in the middle of the memory die.

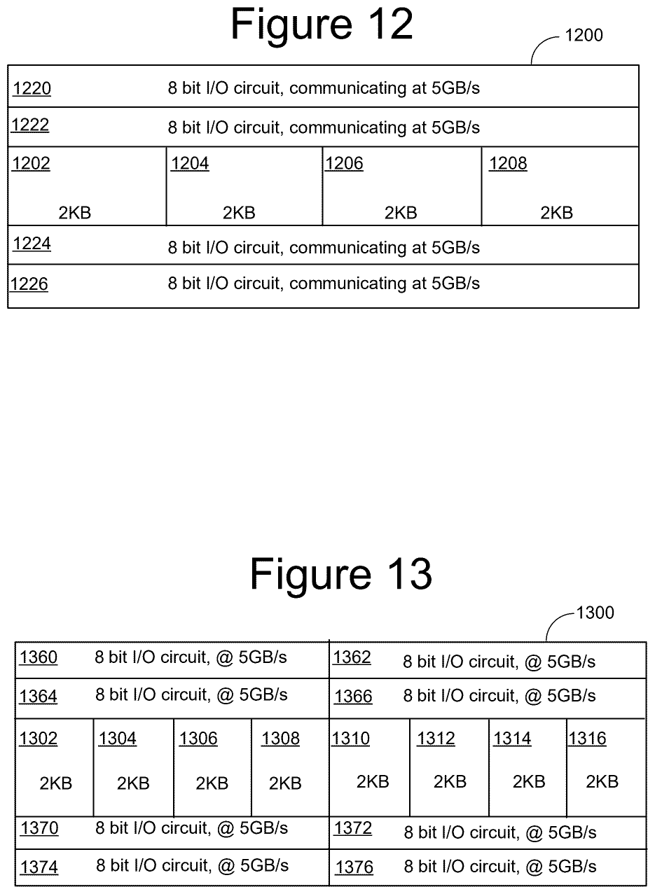

FIG. 12 is a block diagram depicting another embodiment of a partial floorplan for a memory die 1200 (i.e., looking down at the memory die). In one embodiment, memory die 1200 can implement the structure of FIG. 2A, the structure of FIG. 2B or a different structure for a non-volatile memory die. Memory die 1200 is an example of a memory die that can be used on each of layers 704-718 depicted in FIG. 7. That is, memory die 1200 can be used to implement die 0, die 1, die 2 and die 3 of FIGS. 8A and 8B for any or all of layers 704-718. Memory die 1200 includes four planes: 1202, 1204, 1206 and 1208. Each plane is divided into pages of 2K Bytes. In the embodiment of FIG. 12, each plane has its own dedicated I/O circuit. For example, plane 1202 is connected to I/O circuit 1220, plane 1204 is connected to I/O circuit 1222, plane 1206 is connected to I/O circuit 1206 and plane 1208 is connected to I/O circuit 1126. The planes are in the middle of the die and the I/O circuits are on the outer edges of the die. I/O circuits 1220, 1222, 1224 and 1226 each implement a separate eight bit data bus and are able to communicate at 5 GB per second. The eight bit data bus is implemented as eight TSVs (see e.g., TSVs 730-748). Since there are four I/O circuits in memory die 1200, then memory die 1200 needs thirty two TSVs for transmitting thirty two bits. A system with four memory die on a level and eight layers would include thirty memory die each using thirty two TSV for a total of 1024 TSV in the stack.

FIG. 13 is a block diagram depicting another embodiment of a partial floorplan for a memory die 1300 (i.e., looking down at the memory die). In one embodiment, memory die 1300 can implement the structure of FIG. 2A, the structure of FIG. 2B or a different structure for a non-volatile memory die. Memory die 1300 is an example of a memory die that can be used on each of layers 704-718 depicted in FIG. 7. That is, memory die 1300 can be used to implement die 0, die 1, die 2 and die 3 of FIGS. 8A and 8B for any or all of layers 704-718. Memory die 1200 includes eight planes: 1302, 1304, 1306, 1308, 1310, 1312, 1314 and 1316. Each plane is divided into pages of 2K Bytes. In the embodiment of FIG. 13, each plane has its own dedicated I/O circuit. For example, plane 1302 is connected to I/O circuit 1360, plane 1304 is connected to I/O circuit 1364, plane 1306 is connected to I/O circuit 1370, plane 1308 is connected to I/O circuit 1374, plane 1310 is connected to I/O circuit 1362, plane 1312 is connected to I/O circuit 1366, plane 1314 is connected to I/O circuit 1372, and plane 1316 is connected to I/O circuit 1376. The planes are in the middle of the die and the I/O circuits are on the outer edges of the die. I/O circuits 1360, 1362, 1364, 1366, 1370, 1372, 1374 and 1376 each implement a separate eight bit data bus and are able to communicate at 5 GB per second. The eight bit data bus is implemented as eight TSVs (see e.g., TSVs 730-748). Since there are eight I/O circuits in memory die 1300, then memory die 1300 needs sixty four TSVs for transmitting sixty four bits. A system with four memory die on a level and eight layers would include thirty memory die each using sixty four TSVs for a total of 2048 TSVs in the stack. The embodiment of FIG. 13 results in the same bandwidth and number of TSVs as the embodiment of FIG. 10.

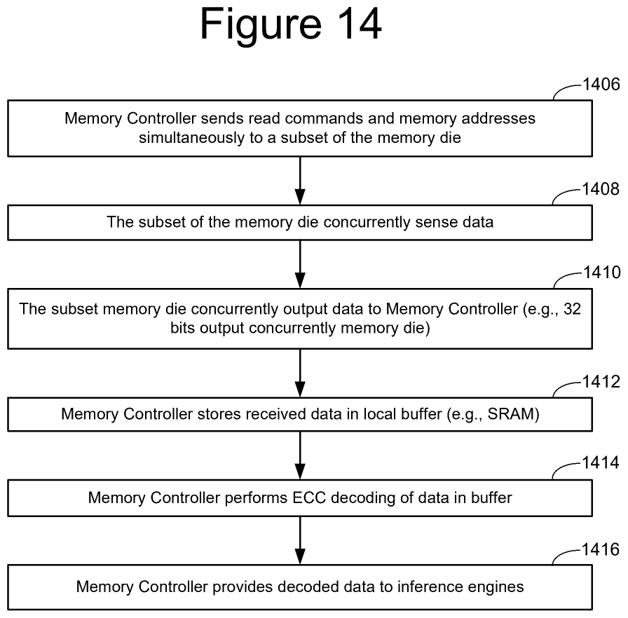

FIG. 14 is a flow chart describing one embodiment of a process for operating an IPU with a high bandwidth read of NAND. The process of FIG. 14 can be performed with the structure of FIGS. 7, implementing any of the embodiments of FIGS. 9-13. The process of FIG. 14 can be performed with any of the IPUs 100 shown and described in FIGS. 1A, 1B, 3A, 3B, 3C, 3D. The logic die 302 of FIG. 4 or 5 may be used in the implementation of the process of FIG. 14. In one embodiment, each of the TSVs discussed above can be used for transmitting commands, addresses and data. In other embodiments, each of the TSVs discussed above are used for transmitting data only and additional TSV's are used to transmit addresses and commands. In some embodiments, addresses and commands are transmitted on different signals and in other embodiments addresses and command are combined.

One example use case is to deploy the non-volatile memory to store a trained model for an inference engine as part of an artificial intelligence application. Typically, the trained model is programmed into the non-volatile memory once and then read many times. To support the input needs of the inference engine, the process of reading the model must be performed at a high bandwidth. Typically, DRAM is used as a High Bandwidth Memory (“HBM”) to store a trained model. However, non-volatile memory can be less expensive then DRAM. Therefore, the process of FIG. 14 may use the non-volatile memory of, but not limited to, FIG. 1B, 2A, 2B, 3A, 3B, 3C, 3D, 3E, or 7 as the HBM to store a trained model (or other data).

In step 1406, Memory Controller 702 sends read commands and page addresses (includes block address) simultaneously to a subset of memory die in the stack depicted in FIG. 3A, 3B, 3C, 3D, 3E or 7. The term “subset” as used herein includes at least one member of the set and may include all members of the set. In step 1406, read commands and page addresses are concurrently sent to up to all thirty two memory die of the eight layers depicted in FIG. 7. Other embodiments may include more or fewer than thirty two memory die. In step 1408, all of memory die that received read commands and addresses concurrently sense data. In step 1410, all of the memory die that sensed data concurrently output data to Memory Controller 702 (e.g., 32 bits output concurrently per non-volatile memory die using the TSV's discussed above). In step 1412, Memory Controller 702 stores the received data in a local buffer (e.g., SRAM). There can be one buffer for data received from all memory die, or a separate buffer in the Memory Controller for each memory die. In step 1414, Memory Controller 702 performs ECC decoding of data stored in the local buffer. In another embodiment, the decoded data is moved to an output buffer rather than remaining in the local buffer where the received data weas initially stored. In step 1416, Memory Controller 702 provides the decoded data to the inference engines 162. The inference engines 162 then perform parallel computations.

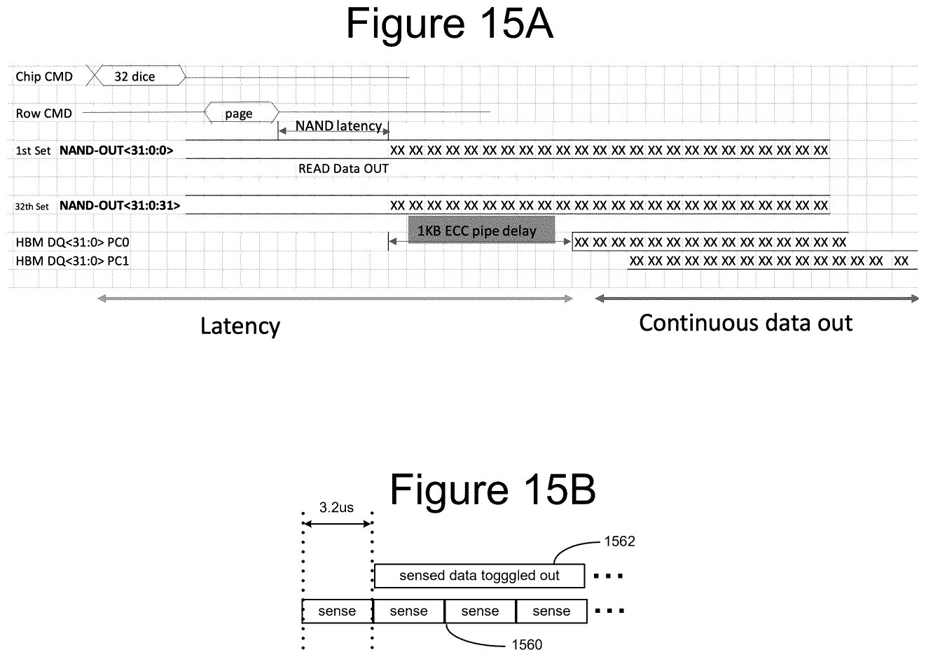

FIG. 15A is a system level timing diagram for a high bandwidth read process (e.g., the process of FIG. 14). In one embodiment, there is a separate Chip CMD signal for each memory die (from Memory Controller 702 to each memory die) that transmits a command to the respective memory die. For example, the Chip CMD signal can transmit the read command of step 1406. In one embodiment, there is a separate Row CMD signal for each memory die (from Memory Controller 702 to each memory die) that transmits an address to each memory die. For example, the Row CMD can transmit the block and page address of step 1406.

FIG. 15A shows the Chip CMD signal transmitting the read command simultaneously to all memory die (e.g., all 32 memory die) followed by Row CMD signal transmitting page addresses to all memory die (step 1406). After the page addresses are received, there is a latency (NAND latency) for the memory die to perform the sensing (step 1408), after which data is toggled out of the memory die to the Memory Controller 702 via the TSVs discussed above (labeled in FIG. 15A as 1^{st} Set NAND-OUT <31:0:0> . . . 32^{nd} Set NAND-OUT <31:0:31> (step 1410). After the data is received by Memory Controller 702 there is an ECC pipe delay (e.g., ECC performed 1 KB at a time for each memory die) while Memory Controller 702 performs the ECC decoding (step 1414). Once the first set of data has been decoded, it is output to the GPU (step 1416) on two 32 bit data buses HBM DQ<31:0> PC0 and HBM DQ<31:0> PC1.

Steps 1406-1416 of the process of FIG. 14 may be repeated many times. However, the latencies depicted in FIG. 15A are only experienced at the first read request of a series of read requests because once the data starts being reported to the GPU the latencies for sensing and ECC are occurring concurrently with transmitting data so there is no additional latency in data reported out to the GPU (as FIG. 15A depicts “Continuous data out”).

FIG. 15B is a timing diagram for a high bandwidth read process at the memory die level. The read process at the memory die level comprises two steps: (1) sensing data and storing that data in local latches at the sense amplifier (e.g., latches are part of column control circuitry 210 of FIGS. 2A and 2B), and (2) transmitting the sensed data from the local latches to the Memory Controller. The bottom row 1560 of FIG. 15B shows the timing of the first step (sensing) and the top row 1562 shows the timing of the second step (transmitting). As mentioned above, in the embodiment of FIG. 9, sensing data takes 3.2 μs. After the first sensing (the first 3.2 us) then the transmitting begins and the sensed data is toggled out to the Memory Controller. In effect, the memory die is a pipeline that senses and transmits so that after the 3.2 us latency, there is no longer a latency and data is continuously pumped out to the Memory Controller.

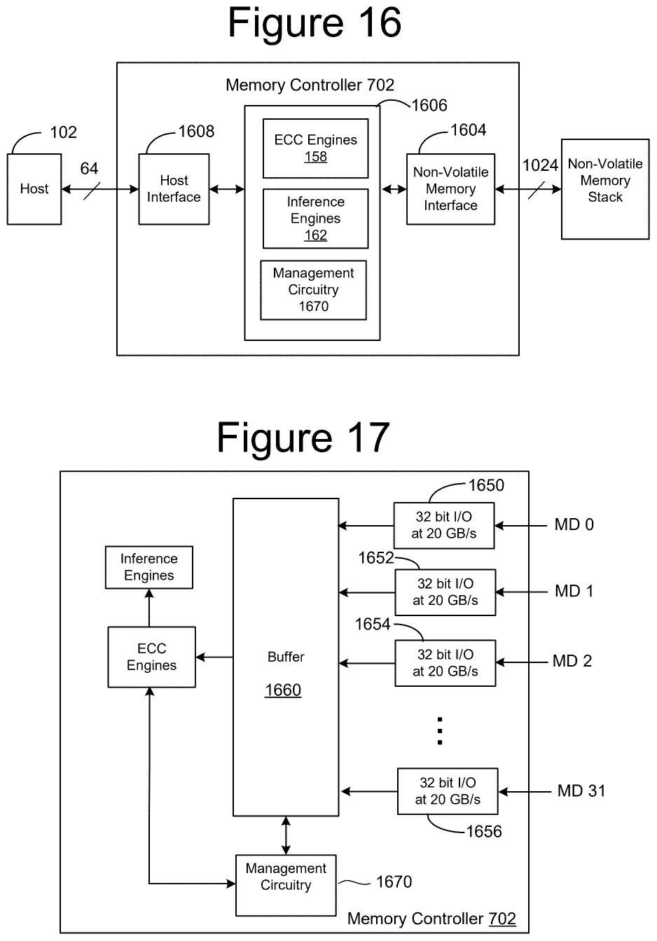

FIG. 16 is a block diagram of a memory controller 702. The memory controller 702 in FIG. 16 may implement the memory controller 302 in FIG. 7. The memory controller 702 may be implemented on an embodiment of a logic die 302. The memory controller 702 may implement a memory controller architecture (or, at least, part of the architecture) of FIG. 1B. In one embodiment, memory controller 702 receives 1024 bits in parallel (or 2048 bits in parallel) from the stack of memory die (see 704-718 in FIG. 7) during a read process and communicates with the host (e.g., host 102) 64 bits in parallel. The 1024 bits received in parallel by Memory Controller 702 from the stack of memory die during a read process is received at non-volatile memory interface 1604 (e.g., memory interface 160 of FIG. 1B), which provides an electrical interface for communication with the memory die. The data received at non-volatile memory interface 1604 is provided to Memory Processing/Management circuit(s) 1606. The Memory Processing/Management circuit have ECC engines 158 to perform ECC decoding. The decoded data is provided to the inference engines 162. Management circuitry 1670 oversees the flow of data. In one embodiment, there is a separate buffer for each memory die. In one embodiment, there is a set of buffers (e.g., 64 KB each or bigger) for receiving the data (e.g., one buffer per memory die), a set of buffers (e.g., 1 KB each or bigger) for ECC processing (e.g., one buffer per memory die) and a set of buffers (e.g., 64 KB each or bigger) for post-ECC data waiting to be provided to an inference engine (e.g., one buffer per memory die). The host Interface 1608 is an electrical circuit for communicating with host 102. The CPU Interface 1608 receives input data from the host 102 and provides inference results to the host 102.

FIG. 17 is a block diagram depicting data flow at Memory Controller 702 during a high bandwidth read process. FIG. 17 shows data received from thirty two memory die (MD 0, MD 1, MD 2, . . . MD 31) at separate interface circuits for each memory die 1650, 1652, 1654, . . . 1656, which together comprise non-volatile memory interface 1604. Data from each memory die is received as 32 bits in parallel at 20 GB per second. and stored in buffer 1660. In one embodiment, buffer 1660 is one large SRAM buffer used to store data from all memory die. In another embodiment, buffer 1660 comprises separate SRAM buffers for each memory die. While in buffer 1660, the data can be operated on by memory manager 1670 (e.g., ECC decoding) and then provided to GPU interface 1608. In other embodiments, buffer 1660 can comprise multiple buffers for each memory die. Buffer 1660 and management circuitry 1670 are part of Memory Processing/Management 1606.

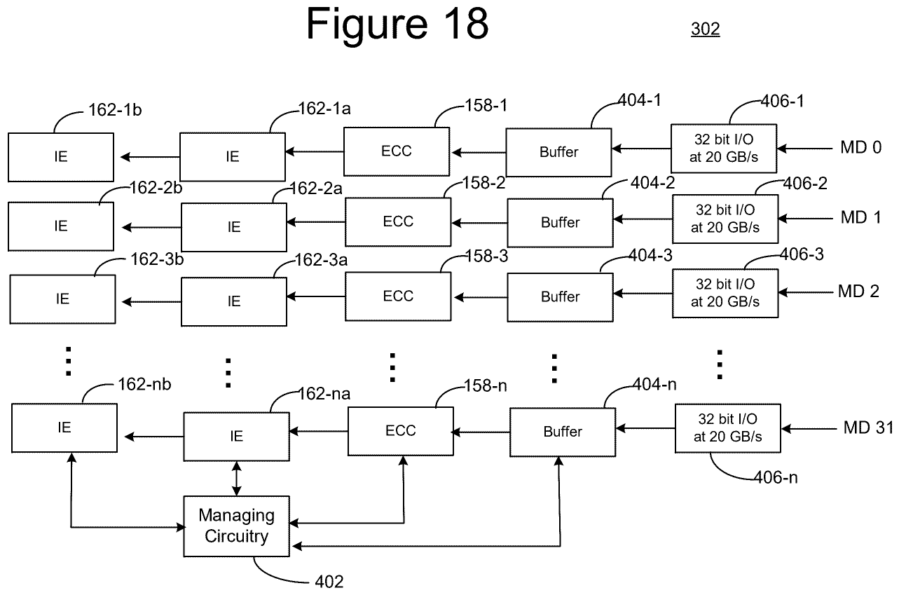

FIG. 18 is a block diagram depicting further details of an embodiment of a logic die 302 having ECC and inference engines. In this example, the logic die 302 on the logic die is connected to thirty two memory die (MD 0, MD 1, MD 2, . . . MD 31). Data received from thirty two memory die (MD 0, MD 1, MD 2, . . . MD 31) at separate interface circuits (406-1, 406-2, 406-3, . . . 406-n) for each memory die is provided to separate buffers (404-1, 404-2, 404-3, . . . 406-n) for each memory die. From the separate buffers (404-1, 404-2, 404-3, . . . 406-n) for each memory die, separate ECC engines (158-1, 158-2, 158-3, . . . 158-n) for each memory die perform ECC decoding (which may include correcting one or more errors in the data). An ECC code word can be between 1 KB to 2 KB; however, larger or smaller ECC code words may be used. The output of the separate ECC engines (158-1, 158-2, 158-3, . . . 158-n) is provided to separate inference engines (162-la, 162-2a, 162-3a, . . . 162-na). In an embodiment, the decoded data from the ECC engines 158 may buffered in, for example, SRAM, prior to providing to the inference engines 162. In one embodiment, managing circuitry 402 is connected to each of the components of FIG. 18 for managing the data flow, ECC operations, and inference computations.

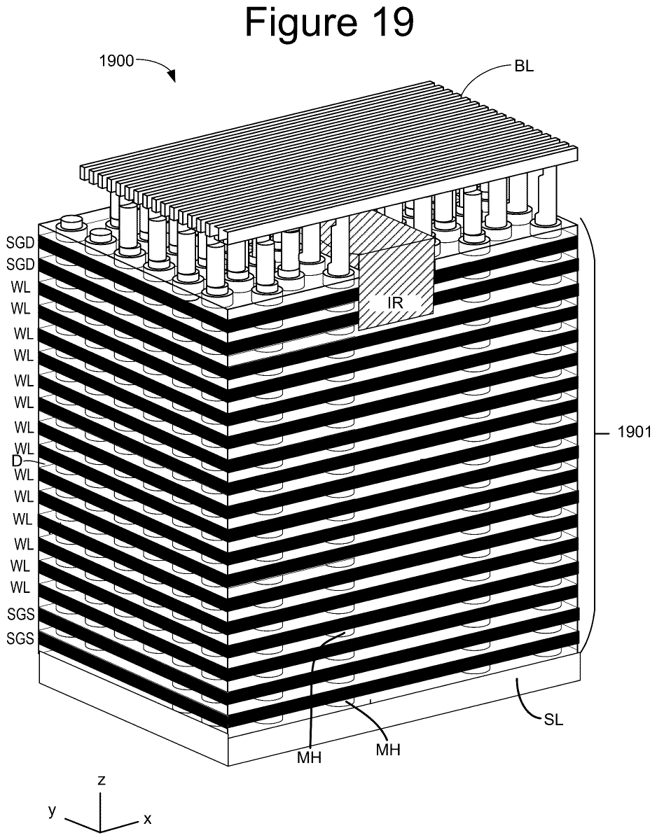

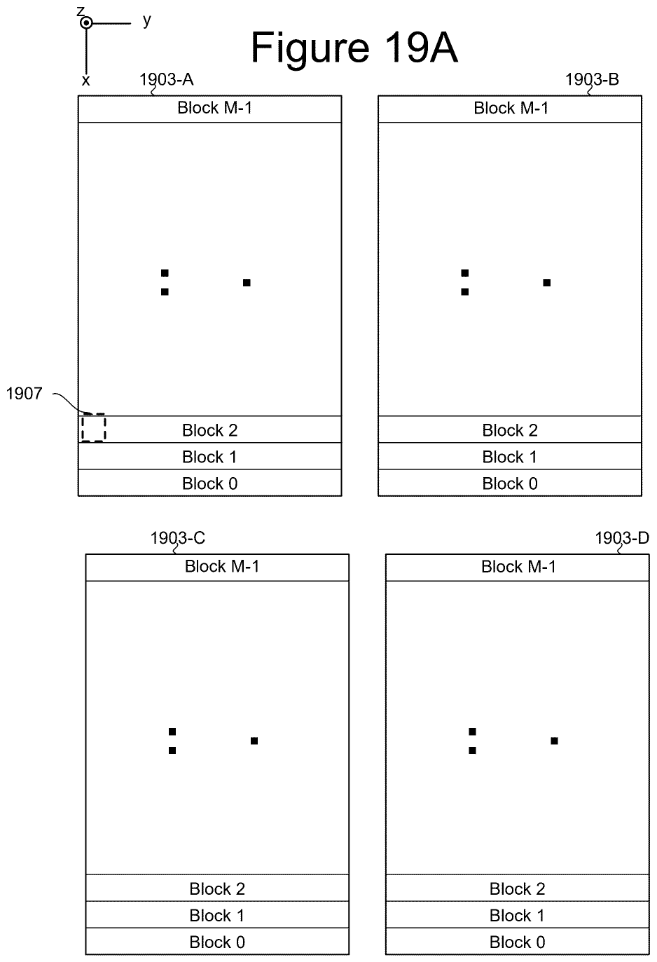

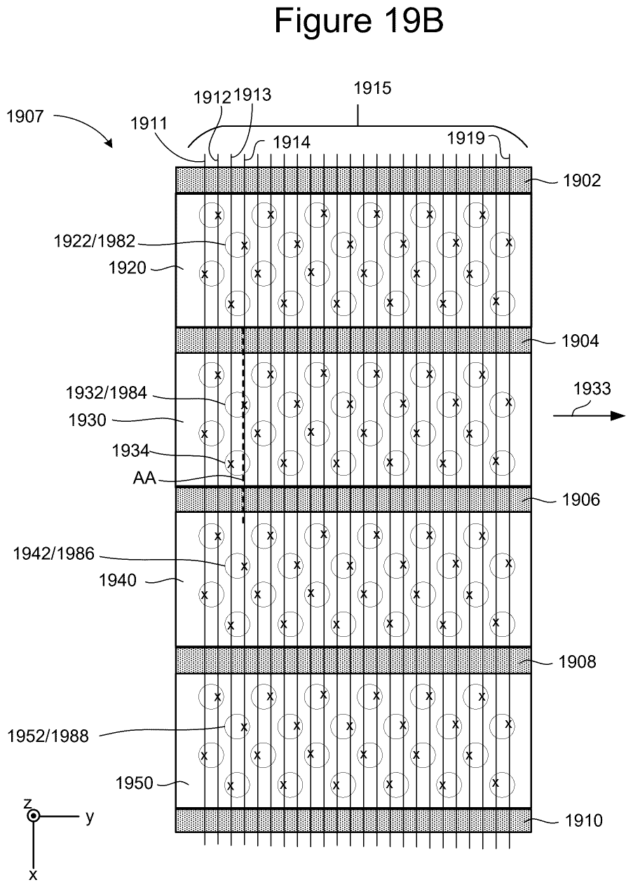

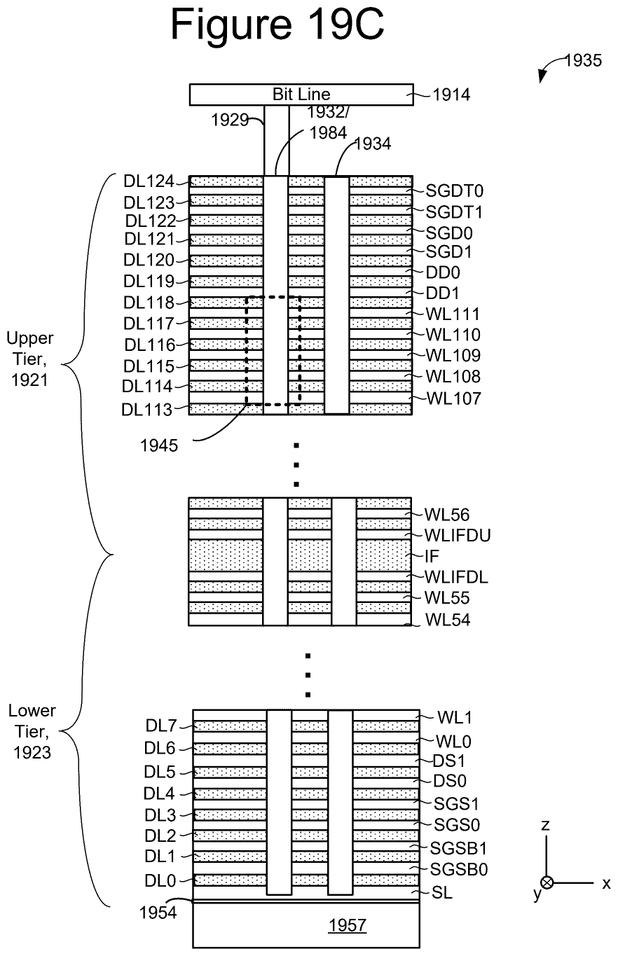

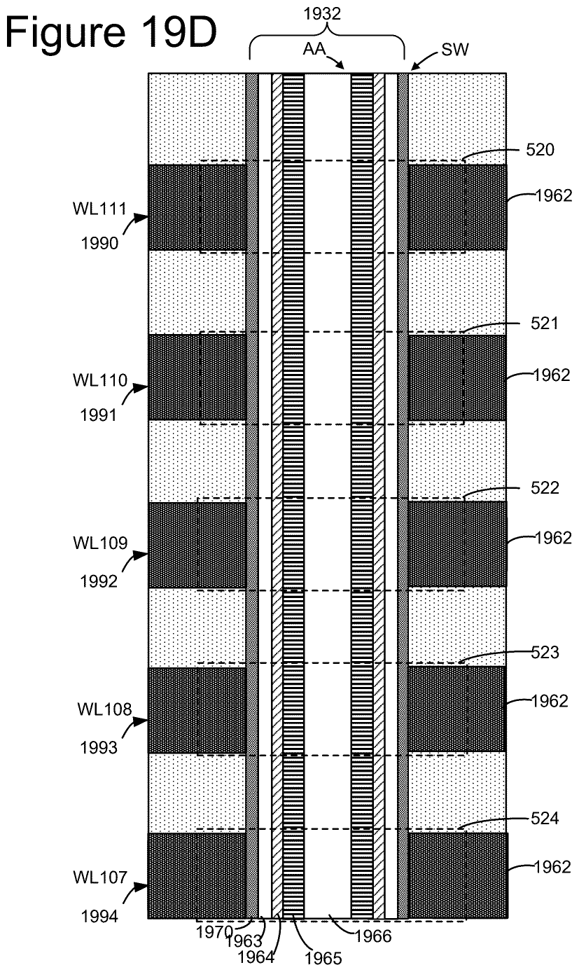

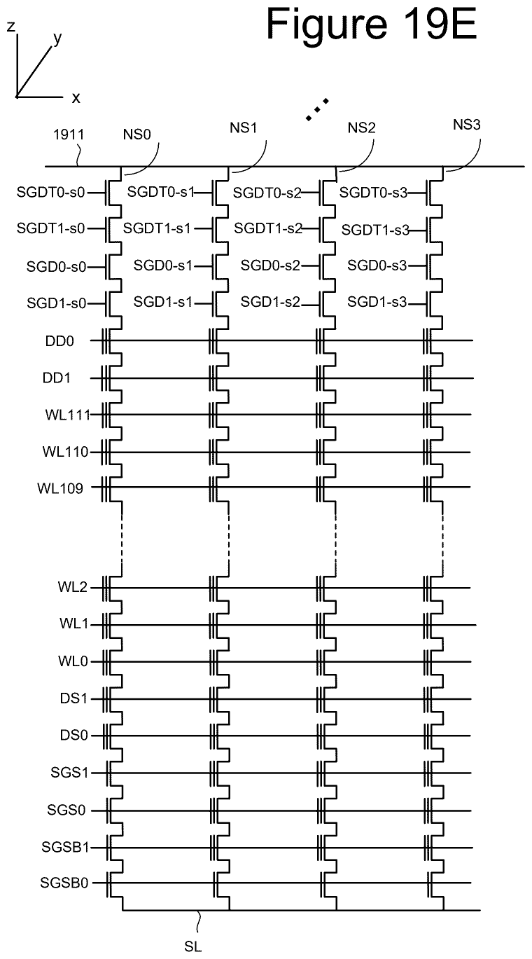

In one embodiment, the non-volatile memory 130 is NAND. The NAND memory may be in a three-dimensional memory structure or a two-dimensional memory structure. FIG. 19 s a perspective view of a portion of one example embodiment of a monolithic three dimensional memory array/structure that can comprise memory structure 202, which includes a plurality non-volatile memory cells arranged as vertical NAND strings. For example, FIG. 19 shows a portion 1900 of one block of memory. The structure depicted includes a set of bit lines BL positioned above a stack 1901 of alternating dielectric layers and conductive layers. For example purposes, one of the dielectric layers is marked as D. The conductive layers are labeled as one of: SGD, WL, or SGS. An SGD conductive layer serves as drain side select lines. A WL conductive layer serves as a word line. An SGS conductive layer serves as a source side select line. The numbers of each of these conductive layers is limited for ease of illustration. The number of alternating dielectric layers and conductive layers can vary based on specific implementation requirements. Below the alternating dielectric layers and word line layers is a source line layer SL. Memory holes are formed in the stack of alternating dielectric layers and conductive layers. For example, one of the memory holes is marked as MH. Note that in FIG. 4, the dielectric layers are depicted as see-through so that the reader can see the memory holes positioned in the stack of alternating dielectric layers and conductive layers. In one embodiment, NAND strings are formed by filling the memory hole with materials including a charge-trapping material to create a vertical column of memory cells. Each memory cell can store one or more bits of data. More details of the three dimensional monolithic memory array that comprises memory structure 202 is provided below.

In one embodiment the block is operated as a number of “sub-blocks.” Each of these “sub-blocks” has many NAND strings. In an embodiment, an isolation region (IR) divides the SGD layers into multiple SGD select lines, each of which is used to select a sub-block (e.g., set of NAND strings). FIG. 4 depicts an example having one IR region and thereby two sub-blocks. However, there may be more than one IR region and thereby more than two sub-blocks. Optionally, the IR region can extend downward through all of the alternating dielectric layers and conductive layers.

FIG. 19A is a block diagram explaining one example organization of memory structure 202, which is divided into four planes 1903-A, 1903-B, 1903-C, and 1903-D. Each plane 1903 is then divided into M physical blocks. In one example, each plane has about 2000 physical blocks (or more briefly “blocks”). However, different numbers of blocks and planes can also be used. In one “full-block” embodiment, a block of memory cells is a unit of erase. That is, all memory cells of a block are erased together. In a “sub-block mode” embodiment, blocks are divided into sub-blocks and the sub-blocks are the unit of erase. In an embodiment, a block contains a number of word lines with each sub-block containing a unique set of the data word lines. In an embodiment, each plane 1903 has a set of bit lines that extend across all of the blocks in that plane. In an embodiment, one block per plane is selected at a time. Memory cells can also be grouped into blocks for other reasons, such as to organize the memory structure to enable the signaling and selection circuits. In some embodiments, a block represents a groups of connected memory cells as the memory cells of a block share a common set of word lines. For example, the word lines for a block are all connected to all of the vertical NAND strings for that block. Although FIG. 4A shows four planes 1903-A, 1903-B, 1903-C, and 1903-D more or fewer than two planes can be implemented. In some embodiments, memory structure 202 includes four planes. In some embodiments, memory structure 202 includes eight planes. In some embodiments, read can be performed in parallel in a first selected block in plane 1903-A, a second selected block in plane 1903-B, a third selected block in plane 1903-C, and a fourth selected block in plane 1903-D.

FIGS. 19B-19E depict an example three dimensional (“3D”) NAND structure that corresponds to the structure of FIG. 19 and can be used to implement memory structure 202 of FIGS. 2A and 2B. FIG. 19B is a diagram depicting a top view of a portion 1907 of Block 2. As can be seen from FIG. 19B, the physical block depicted in FIG. 19B extends in the direction of arrow 1933. In one embodiment, the memory array has many layers; however, FIG. 19B only shows the top layer.

FIG. 19B depicts a plurality of circles that represent the vertical columns. Each of the vertical columns include multiple select transistors (also referred to as a select gate or selection gate) and multiple memory cells. In one embodiment, each vertical column implements a NAND string. For example, FIG. 19B depicts vertical columns 1922, 1932, 1942, and 1952. Vertical column 1922 implements NAND string 1982. Vertical column 1932 implements NAND string 1984. Vertical column 1942 implements NAND string 1986. Vertical column 1952 implements NAND string 1988. More details of the vertical columns are provided below. Since the physical block depicted in FIG. 19B extends in the direction of arrow 1933, the physical block includes more vertical columns than depicted in FIG. 19B.

FIG. 19B also depicts a set of bit lines 1915, including bit lines 1911, 1912, 1913, 1914, . . . 1919. FIG. 19B shows twenty-four bit lines because only a portion of the physical block is depicted. It is contemplated that more than twenty-four bit lines connected to vertical columns of the physical block. Each of the circles representing vertical columns has an “x” to indicate its connection to one bit line. For example, bit line 1914 is connected to vertical columns 1922, 1932, 1942 and 1952.

The physical block depicted in FIG. 19B includes a set of isolation regions 1902, 1904, 1906, 1908, and 1910, which are formed of SiO₂; however, other dielectric materials can also be used. Isolation regions 1902, 1904, 1906, 1908, and 1910 serve to divide the top layers of the physical block into four regions; for example, the top layer depicted in FIG. 19B is divided into regions 1920, 1930, 1940, and 1950, which are referred to herein as “sub-blocks. Each sub-block contains a large number of NAND strings. In one embodiment, isolation regions 1902 and 1910 separate the physical block 1907 from adjacent physical blocks. Thus, isolation regions 1902 and 1910 may extend down to the substrate. In one embodiment, the isolation regions 1904, 1906, and 1908 only divide the layers used to implement select gates so that NAND strings in different sub-blocks can be independently selected. Referring back to FIG. 19, the IR region may correspond to any of isolation regions 1904, 1906, or 1908. In one example implementation, a bit line only connects to one vertical column/NAND string in each of regions (sub-blocks) 1920, 1930, 1940, and 1950. In that implementation, each physical block has sixteen rows of active columns and each bit line connects to four NAND strings in each block. In one embodiment, all of the four vertical columns/NAND strings connected to a common bit line are connected to the same word line (or set of word lines); therefore, the system uses the drain side selection lines to choose one (or another subset) of the four to be subjected to a memory operation (program, verify, read, and/or erase).

Although FIG. 19B shows each region (1920, 1930, 1940, 1950) having four rows of vertical columns, four regions (1920, 1930, 1940, 1950) and sixteen rows of vertical columns in a block, those exact numbers are an example implementation. Other embodiments may include more or fewer regions (1920, 1930, 1940, 1950) per block, more or fewer rows of vertical columns per region and more or fewer rows of vertical columns per block. FIG. 19B also shows the vertical columns being staggered. In other embodiments, different patterns of staggering can be used. In some embodiments, the vertical columns are not staggered.

FIG. 19C depicts an example of a stack 1935 showing a cross-sectional view along line AA of FIG. 19B. The SGD layers include SGDT0, SGDT1, SGD0, and SGD1. The SGD layers may have more or fewer than four layers. The SGS layers includes SGSB0, SGSB1, SGS0, and SGS1. The SGS layers may have more or fewer than four layers. Six dummy word line layers DD0, DD1, WLIFDU, WLIDDL, DS1, and DS0 are provided, in addition to the data word line layers WL0-WL111. There may be more or fewer than 112 data word line layers and more or fewer than six dummy word line layers. Each NAND string has a drain side select gate at the SGD layers. Each NAND string has a source side select gate at the SGS layers. Also depicted are dielectric layers DL0-DL124.

Columns 1932, 1934 of memory cells are depicted in the multi-layer stack. The stack includes a substrate 1957, an insulating film 1954 on the substrate, and a portion of a source line SL. A portion of the bit line 1914 is also depicted. Note that NAND string 1984 is connected to the bit line 1914. NAND string 1984 has a source-end at a bottom of the stack and a drain-end at a top of the stack. The source-end is connected to the source line SL. A conductive via 1929 connects the drain-end of NAND string 1984 to the bit line 1914.

In one embodiment, the memory cells are arranged in NAND strings. The word line layers WL0-WL111 connect to memory cells (also called data memory cells). Dummy word line layers DD0, DD1, DS0 and DS1 connect to dummy memory cells. A dummy memory cell does not store and is not eligible to store host data (data provided from the host, such as data from a user of the host), while a data memory cell is eligible to store host data. In some embodiments, data memory cells and dummy memory cells may have the same structure. Drain side select layers SGD are used to electrically connect and disconnect (or cut off) the channels of respective NAND strings from bit lines. Source side select layers SGS are used to electrically connect and disconnect (or cut off) the channels of respective NAND strings from the source line SL.

FIG. 19C depicts an example of a stack 1935 having two tiers (lower tier 1923, upper tier 1921). A two tier or other multi-tier stack can be used to form a relatively tall stack while maintaining a relatively narrow memory hole width (or diameter). After the layers of the lower tier are formed, memory hole portions are formed in the lower tier. Subsequently, after the layers of the upper tier are formed, memory hole portions are formed in the upper tier, aligned with the memory hole portions in the lower tier to form continuous memory holes from the bottom to the top of the stack. The resulting memory hole is narrower than would be the case if the hole were etched from the top to the bottom of the stack rather than in each tier individually. An interface (IF) region is created where the two tiers are connected. The IF region is typically thicker than the other dielectric layers. Due to the presence of the IF region, the adjacent word line layers suffer from edge effects such as difficulty in programming or erasing. These adjacent word line layers can therefore be set as dummy word lines (WLIFDL, WLIFDU). In some embodiments, the tiers are erased independent of one another. Hence, data may be maintained in the upper tier 1921 after the lower tier 1923 is erased. Likewise, data may be maintained in the lower tier 1923 after upper tier 1921 is erased.

FIG. 19D depicts a view of the region 1945 of FIG. 19C. Data memory cell transistors 520, 521, 522, 523, and 524 are indicated by the dashed lines. A number of layers can be deposited along the sidewall (SW) of the memory hole 1932 and/or within each word line layer, e.g., using atomic layer deposition. For example, each column (e.g., the pillar which is formed by the materials within a memory hole) can include a blocking oxide/block high-k material 1970, charge-trapping layer or film 1963 such as SiN or other nitride, a tunneling layer 1964, a polysilicon body or channel 1965, and a dielectric core 1966. A word line layer can include a conductive metal 1962 such as Tungsten as a control gate. For example, control gates 1990, 1991, 1992, 1993 and 1994 are provided. In this example, all of the layers except the metal are provided in the memory hole. In other approaches, some of the layers can be in the control gate layer. Additional pillars are similarly formed in the different memory holes. A pillar can form a columnar active area (AA) of a NAND string.

When a data memory cell transistor is programmed, electrons are stored in a portion of the charge-trapping layer which is associated with the data memory cell transistor. These electrons are drawn into the charge-trapping layer from the channel, and through the tunneling layer. The Vt of a data memory cell transistor is increased in proportion to the amount of stored charge. During an erase operation, the electrons return to the channel.

Each of the memory holes can be filled with a plurality of annular layers (also referred to as memory film layers) comprising a blocking oxide layer, a charge trapping layer, a tunneling layer and a channel layer. A core region of each of the memory holes is filled with a body material, and the plurality of annular layers are between the core region and the WLLs in each of the memory holes. In some cases, the tunneling layer 1964 can comprise multiple layers such as in an oxide-nitride-oxide configuration.

FIG. 19E is a schematic diagram of a portion of the memory array 202. FIG. 4E shows physical data word lines WL0-WL111 running in the x-direction. The physical data word lines WL0-WL111 may also extend in the y-direction across the entire extent of the block. Therefore, each word line connects to many more NAND strings in the block. The structure of FIG. 19E corresponds to a portion 1907 in Block 2 of FIG. 19A, including bit line 1911. Within the physical block, in one embodiment, each bit line is connected to four NAND strings. Thus, FIG. 19E shows bit line 411 connected to NAND string NS0, NAND string NS1, NAND string NS2, and NAND string NS3.

In one embodiment, there are four sets of drain side select lines in the physical block. For example, the set of drain side select lines connected to NS0 include SGDT0-s0, SGDT1-s0, SGD0-s0, and SGD1-s0. Each of these drain side select lines SGDT0-s0, SGDT1-s0, SGD0-s0, and SGD1-s0 extends in the y-direction across the entire extent of the block such that each drain side select line connects to many NAND strings in the block. The set of drain side select lines connected to NS1 include SGDT0-s1, SGDT1-s1, SGD0-s1, and SGD1-s1. The set of drain side select lines connected to NS2 include SGDT0-s2, SGDT1-s2, SGD0-s2, and SGD1-s2. The set of drain side select lines connected to NS3 include SGDT0-s3, SGDT1-s3, SGD0-s3, and SGD1-s3. Herein the term “SGD” may be used as a general term to refer to any one or more of the lines in a set of drain side select lines. In some embodiments, the same operating voltage is applied to SGDT0 and SGDT1. In some embodiments, the same operating voltage is applied to SGD0 and SGD1. In some erase embodiments, different operating voltage are applied to SGDT0/SGDT1 than to SGD0/SGD1. Note that SGDT0/SGDT1 are adjacent to the bit line. In some erase embodiments, a voltage applied to SGDT0/SGDT1 in combination with a bit line voltage may be used to generate a gate induced gate leakage (GIDL) current. Such a voltage applied to SGDT0/SGDT1 may be referred to herein as a GIDL voltage.

In an embodiment, each line in a given set may be operated independent from the other lines in that set to allow for different voltages to the gates of the four drain side select transistors on the NAND string. Moreover, each set of drain side select lines can be selected independent of the other sets. Each set drain side select lines connects to a group of NAND strings in the block. Only one NAND string of each group is depicted in FIG. 19E. These four sets of drain side select lines correspond to four “sub-blocks.” A first sub-block corresponds to those vertical NAND strings controlled by SGDT0-s0, SGDT1-s0, SGD0-s0, and SGD1-s0. A second sub-block corresponds to those vertical NAND strings controlled by SGDT0-s1, SGDT1-s1, SGD0-s1, and SGD1-s1. A third sub-block corresponds to those vertical NAND strings controlled by SGDT0-s2, SGDT1-s2, SGD0-s2, and SGD1-s2. A fourth sub-block corresponds to those vertical NAND strings controlled by SGDT0-s3, SGDT1-s3, SGD0-s3, and SGD1-s3. As noted, FIG. 4E only shows the NAND strings connected to bit line 1911. However, a full schematic of the block would show every bit line and four vertical NAND strings connected to each bit line.

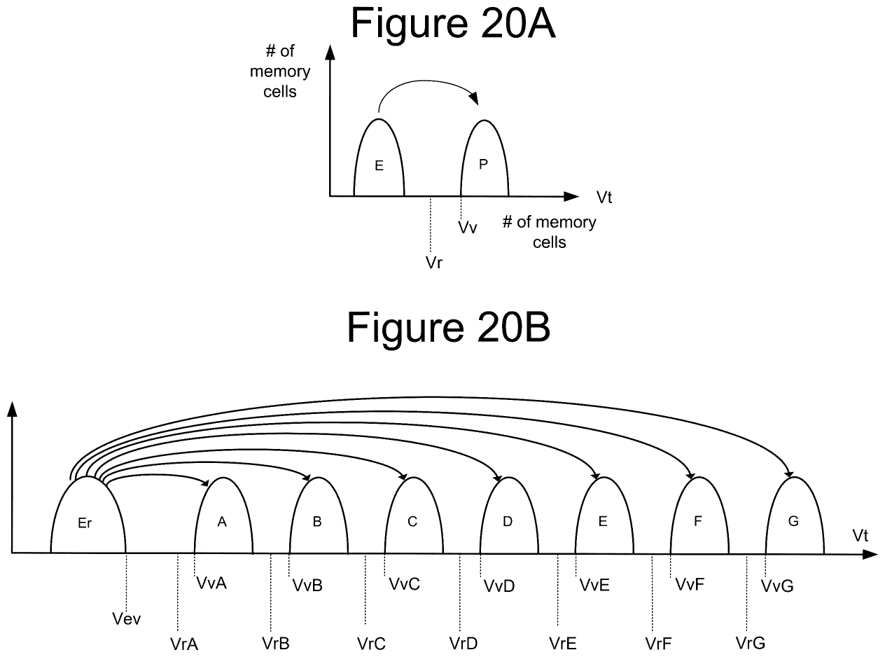

The storage systems discussed above can be erased, programmed and read. At the end of a successful programming process, the threshold voltages of the memory cells should be within one or more distributions of threshold voltages for programmed memory cells or within a distribution of threshold voltages for erased memory cells, as appropriate. FIG. 20A is a graph of threshold voltage versus number of memory cells, and illustrates example threshold voltage distributions for the memory array when each memory cell stores one bit of data per memory cell. Memory cells that store one bit of data per memory cell data are referred to as single level cells (“SLC”). The data stored in SLC memory cells is referred to as SLC data; therefore, SLC data comprises one bit per memory cell. Data stored as one bit per memory cell is SLC data. FIG. 20A shows two threshold voltage distributions: E and P. Threshold voltage distribution E corresponds to an erased data state. Threshold voltage distribution P corresponds to a programmed data state. Memory cells that have threshold voltages in threshold voltage distribution E are, therefore, in the erased data state (e.g., they are erased). Memory cells that have threshold voltages in threshold voltage distribution P are, therefore, in the programmed data state (e.g., they are programmed). In one embodiment, erased memory cells store data “1” and programmed memory cells store data “0.” FIG. 20A depicts read reference voltage Vr. By testing (e.g., performing one or more sense operations) whether the threshold voltage of a given memory cell is above or below Vr, the system can determine whether a memory cells is erased (state E) or programmed (state P). FIG. 20A also depicts verify reference voltage Vv. In some embodiments, when programming memory cells to data state P, the system will test whether those memory cells have a threshold voltage greater than or equal to Vv.

Memory cells that store multiple bit per memory cell data are referred to as multi-level cells (“MLC”). The data stored in MLC memory cells is referred to as MLC data; therefore, MLC data comprises multiple bits per memory cell. Data stored as multiple bits of data per memory cell is MLC data. In the example embodiment of FIG. 20B, each memory cell stores three bits of data. Other embodiments may use other data capacities per memory cell (e.g., such as two, four, or five bits of data per memory cell).

FIG. 20B shows eight threshold voltage distributions, corresponding to eight data states. The first threshold voltage distribution (data state) Er represents memory cells that are erased. The other seven threshold voltage distributions (data states) A-G represent memory cells that are programmed and, therefore, are also called programmed states. Each threshold voltage distribution (data state) corresponds to predetermined values for the set of data bits. The specific relationship between the data programmed into the memory cell and the threshold voltage levels of the cell depends upon the data encoding scheme adopted for the cells. In one embodiment, data values are assigned to the threshold voltage ranges using a Gray code assignment so that if the threshold voltage of a memory erroneously shifts to its neighboring physical state, only one bit will be affected.

FIG. 20B shows seven read reference voltages, VrA, VrB, VrC, VrD, VrE, VrF, and VrG for reading data from memory cells. By testing (e.g., performing sense operations) whether the threshold voltage of a given memory cell is above or below the seven read reference voltages, the system can determine what data state (i.e., A, B, C, D, . . . ) a memory cell is in. FIG. 20B also shows a number of verify reference voltages. The verify high voltages are VvA, VvB, VvC, VvD, VvE, VvF, and VvG. In some embodiments, when programming memory cells to data state A, the system will test whether those memory cells have a threshold voltage greater than or equal to VvA. If the memory cell has a threshold voltage greater than or equal to VvA, then the memory cell is locked out from further programming. Similar reasoning applies to the other data states.

A IPU has been proposed that can perform a high bandwidth of non-volatile memory such as NAND.

One embodiment includes an apparatus comprising one or more memory dies comprising non-volatile memory cells and a logic die connected to the one or more memory dies. The logic die comprises a plurality of inference engines and a plurality of error correction code (ECC) engines. The logic die is configured to read encoded data from the non-volatile memory cells of the one or more memory dies. The logic die is configured to decode the encoded data using the plurality of ECC engines to generate decoded data, the decoded data being parameters of an artificial intelligence (AI) model. The logic die is configured to provide the AI parameters to the plurality of inference engines. The logic die is configured to run the plurality of inference engines in parallel to generate an inference result for the AI model.

In one example implementation of the apparatus, the one or more memory dies reside in a stack having a lower surface. The one or more memory dies each have separate parallel through silicon vias (TSVs), each TSV having an end at the lower surface. The logic die has an upper surface connected to the lower surface of the stack. The logic die has input/output (I/O) circuitry in communication with the ends of the TSVs at the lower surface of the stack.

In one example implementation of the apparatus the one or more memory dies comprise a plurality of memory dies. The logic die is configured to read the encoded data in parallel from the plurality of memory dies. The logic die is configured to decode the encoded data from the plurality of memory dies in parallel using the plurality of ECC engines to generate the decoded data.

In one example implementation the apparatus further comprises a substrate and a host residing on a surface of a substrate. The logic die is configured to receive the parameters of the artificial intelligence (AI) model from the host, wherein the logic die resides on the surface of the substrate. The logic die is configured to store the parameters into the non-volatile memory cells of the one or more memory dies. The logic die may encode the parameters with the ECC engine prior to storage.

In one example implementation the apparatus further comprises a substrate and a host residing on a surface of a substrate. The logic die is configured to receive input data from the host, wherein the logic die resides on the surface of the substrate. The logic die is configured to provide the inference result for the input data to the host.

In one example implementation the apparatus further comprises a printed circuit board (PCB) having a surface, wherein the logic die resides on the surface of the PCB. The apparatus further comprises a processing unit residing on the surface of the PCB. The processing unit is communicatively coupled with the logic die by PCB traces of the PCB. The logic die is configured to provide the inference result to the processing unit.

In one example implementation the logic die is further configured to store intermediate results from a first subset of the plurality of inference engines into a subset of the one or more memory dies. The logic die is further configured to access the intermediate results from the subset of the one or more memory dies. The logic die is further configured to provide the intermediate results read from the subset of the one or more memory dies to a second subset of the one or more inference engines.

In one example implementation the one or more memory dies comprise a plurality of memory dies that form a stack having levels with at least one memory die per level of the stack. The stack includes separate parallel through silicon vias (TSVs) for each memory die in the stack. The logic die is further configured to perform a high bandwidth read of multiple memory dies in the stack in parallel by way of the through silicon vias in parallel and provide the data from the multiple memory dies in the stack to the one or more inference engines.

In one example implementation the stack further comprises a level having DRAM. The logic die is further configured to store intermediate results from a first subset of the plurality of inference engines into the DRAM. The logic die is further configured to access the intermediate results from the DRAM. The logic die is further configured to provide the intermediate results read from the DRAM to a second subset of the one or more inference engines.

In one example implementation each level of the stack has multiple memory dies. The logic die is configured to perform the high bandwidth read of the multiple memory dies of at least one level in parallel. The logic die is configured to provide the data from the multiple memory dies of at least one level in parallel to the one or more inference engines.

In one example implementation an individual memory die comprises a plurality of planes each having a subset of the non-volatile memory cells. The individual memory die is configured to read data from a plurality of the planes and transfer the data read from the plurality of the planes in parallel to the logic die.

In one example implementation the non-volatile memory cells comprise NAND memory cells.

In one example implementation the non-volatile memory cells comprise Flash memory cells.

In one example implementation an individual memory die comprises a plurality of planes having non-volatile memory cells. The individual memory die has a plurality of independent input/output (I/O) circuits. Each plane associated with one of the plurality of independent I/O circuits. The logic die is configured to perform a high bandwidth read of the non-volatile memory cells of the one or more memory dies including receiving data in parallel from the plurality of independent I/O circuits of at least one of the one or more memory dies. The logic die is configured to provide the data from the received data in parallel from the plurality of independent I/O circuits to the inference engines.

One embodiment includes a method comprising receiving, at a logic die residing on a surface of a substrate, input data from a host processor residing on the surface of the substrate. The method includes transferring data in parallel from a plurality of planes in one or more NAND memory dies to the logic die. The method includes performing parallel computation by inferences engines on the logic die on the input data using the data read in parallel from the plurality of planes to generate an inference result for the input data. The method includes providing the inference result from the logic die to the host processor.

One embodiment includes a system comprising a stack comprising NAND memory dies. Each NAND memory die has NAND memory cells. The stack has a lower surface. The stack include separate parallel through silicon vias (TSVs) for each NAND memory die, each via having an end at the lower surface of the stack. The system includes a logic die having a top surface opposing the lower surface of the stack. The logic die has input/output (I/O) circuitry connected to the ends of the TSVs. The logic die comprises a plurality of inference engines. The logic die having a control circuit configured to perform a high bandwidth read of data stored in the NAND memory dies by way of the TSVs. The control circuit is configured to provide the data to the plurality of inference engines. The control circuit is configured to operate the plurality of inference engines in parallel on the data to generate an inference result.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via one or more intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects. For purposes of this document, the term “subset” of objects refers to at least one of the objects in the set and may include all of the objects in the set.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. An apparatus, comprising:
one or more memory dies comprising non-volatile memory cells; and
a logic die connected to the one or more memory dies, the logic die comprising a plurality of inference engines and a plurality of error correction code (ECC) engines, the logic die configured to:
read encoded data from the non-volatile memory cells of the one or more memory dies;
decode the encoded data using the plurality of ECC engines to generate decoded data, the decoded data being parameters of an artificial intelligence (AI) model;
provide the AI parameters to the plurality of inference engines; and
run the plurality of inference engines in parallel to generate an inference result for the AI model.

2. The apparatus of claim 1, wherein:
the one or more memory dies reside in a stack having a lower surface;
the one or more memory dies each have separate parallel through silicon vias (TSVs), each TSV having an end at the lower surface;
the logic die has an upper surface connected to the lower surface of the stack; and
the logic die has input/output (I/O) circuitry in communication with the ends of the TSVs at the lower surface of the stack.

3. The apparatus of claim 1, wherein:
the one or more memory dies comprise a plurality of memory dies; and
the logic die is configured to:
read the encoded data in parallel from the plurality of memory dies; and
decode the encoded data from the plurality of memory dies in parallel using the plurality of ECC engines to generate the decoded data.

4. The apparatus of claim 1, wherein:
the apparatus further comprises a substrate and a host residing on a surface of a substrate; and
the logic die is configured to:
receive the parameters of the artificial intelligence (AI) model from the host, wherein the logic die resides on the surface of the substrate; and
store the parameters into the non-volatile memory cells of the one or more memory dies.

5. The apparatus of claim 1, wherein:
the apparatus further comprises a substrate and a host residing on a surface of a substrate; and
the logic die is configured to:
receive input data from the host, wherein the logic die resides on the surface of the substrate; and
provide the inference result for the input data to the host.

6. The apparatus of claim 1, further comprising:
a printed circuit board (PCB) having a surface, wherein the logic die resides on the surface of the PCB; and
a processing unit residing on the surface of the PCB, the processing unit communicatively coupled with the logic die by PCB traces of the PCB, wherein the logic die is configured to provide the inference result to the processing unit.

7. The apparatus of claim 1, wherein the logic die is further configured to:
store intermediate results from a first subset of the plurality of inference engines into a subset of the one or more memory dies;
access the intermediate results from the subset of the one or more memory dies; and
provide the intermediate results read from the subset of the one or more memory dies to a second subset of the one or more inference engines.

8. The apparatus of claim 1, wherein:
the one or more memory dies comprise a plurality of memory dies that form a stack having levels with at least one memory die per level of the stack, the stack includes separate parallel through silicon vias (TSVs) for each memory die in the stack; and
the logic die is further configured to:
perform a high bandwidth read of multiple memory dies in the stack in parallel by way of the through silicon vias in parallel; and
provide the data from the multiple memory dies in the stack to the one or more inference engines.

9. The apparatus of claim 8, wherein:
the stack further comprises a level having DRAM;
the logic die is further configured to:
store intermediate results from a first subset of the plurality of inference engines into the DRAM;
access the intermediate results from the DRAM; and
provide the intermediate results read from the DRAM to a second subset of the one or more inference engines.

10. The apparatus of claim 1, wherein an individual memory die comprises a plurality of planes each having a subset of the non-volatile memory cells; and
the individual memory die is configured to:
read data from a plurality of the planes; and
transfer the data read from the plurality of the planes in parallel to the logic die.

11. The apparatus of claim 1, wherein the non-volatile memory cells comprise NAND memory cells.

12. The apparatus of claim 1, wherein the non-volatile memory cells comprise Flash memory cells.

13. The apparatus of claim 1, wherein:
an individual memory die comprises a plurality of planes having non-volatile memory cells, the individual memory die having a plurality of independent input/output (I/O) circuits, each plane associated with one of the plurality of independent I/O circuits;
the logic die is configured to perform a high bandwidth read of the non-volatile memory cells of the one or more memory dies including receiving data in parallel from the plurality of independent I/O circuits of at least one of the one or more memory dies; and
provide the data from the received data in parallel from the plurality of independent I/O circuits to the inference engines.

14. A method comprising:
receiving, at a logic die residing on a surface of a substrate, input data from a host processor residing on the surface of the substrate;
transferring data in parallel from a plurality of planes in one or more NAND memory dies to the logic die;
performing parallel computation by inferences engines on the logic die on the input data using the data read in parallel from the plurality of planes to generate an inference result for the input data; and
providing the inference result from the logic die to the host processor.

15. The method of claim 14, further comprising
decoding the data from the plurality of planes at the logic die in parallel using a plurality of error correction code (ECC) circuits; and
providing the decoded data to the inferences engines for the parallel computation.

16. A system, comprising:
a stack comprising NAND memory dies, each NAND memory die having NAND memory cells, the stack having a lower surface, the stack including separate parallel through silicon vias (TSVs) for each NAND memory die, each via having an end at the lower surface of the stack; and
a logic die having a top surface opposing the lower surface of the stack, the logic die having input/output (I/O) circuitry connected to the ends of the TSVs, the logic die comprising a plurality of inference engines, the logic die having a control circuit configured to:
perform a high bandwidth read of data stored in the NAND memory dies by way of the TSVs;
provide the data to the plurality of inference engines; and
operate the plurality of inference engines in parallel on the data to generate an inference result.

17. The system of claim 16, wherein the logic die further comprises:
one or more error correction code (ECC) engines configured to decode encoded data read from the NAND memory cells of the one or more memory dies prior to providing the decoded data to the one or more inference engines.

18. The system of claim 16, further comprising:
a substrate having a surface, wherein the logic die resides on the surface of the substrate; and
a host processor residing on the surface of the substrate.

19. The system of claim 18, wherein the logic die is configured to:
receive input data from the host processor;
run the inference engines on the input data; and
provide inference results for the input data to the host processor.

20. The system of claim 16, wherein:
each memory die comprises multiple planes, groups of planes form banks, each memory die has multiple I/O circuits such that there is one I/O circuit per bank, the stack includes separate parallel TSV's for each bank of each memory die; and
the I/O circuitry of the logic die has a direct connection to each of the banks.
